(19) United States
(12) Patent Application Publication
(10) Pub. No.: US 2025/0036997 A1
(43) Pub. Date: Jan. 30, 2025

(54) QUANTUM VARIABLES IMPLEMENTATION

(71) Applicants: International Business Machines Corporation, Armonk, NY (US); Consiglio Nazionale delle Ricerche, Rome (IT)

(72) Inventors: Gabriele Francesco Maria Agliardi, Milano (IT); Enrico Prati, Milano (IT)

(21) Appl. No.: 18/414,507

(22) Filed: Jan. 17, 2024

(30) Foreign Application Priority Data
Jul. 13, 2023 (IT) 102023000014703

(51) Int. Cl. G06N 10/60; G06F 7/499

(52) U.S. Cl. CPC G06N 10/60; G06F 7/49915

(57) ABSTRACT

The present disclosure relates to a method comprising: providing a quantum register comprising a set of qubits defining a quantum system. The states of a computational basis of the quantum system may be represented by an ordered set of consecutive nonnegative integer numbers, referred to as a set of indexes. A random variable may be determined in accordance with a predefined classical-quantum format, wherein the random variable is valued in a finite domain of classical values such that each value of the domain is derived from a respective index of the set of indexes through an affine relationship, the affine relationship being defined by a scaling factor and an offset factor. The set of qubits may be encoded such that the probability of measuring a state of the quantum system in the computational basis is the probability of observing the domain value associated with the index representing said measured state when sampling the random variable.

### BACKGROUND

The present invention relates to the field of digital computer systems, and more specifically, to a method for determining quantum variables.

The relevance of quantum floating-point arithmetic is paramount across multiple application fields. However, the precision of a floating-point variable degrades significantly as an effect of repeated arithmetic manipulations, when the register size is fixed and a no-overflow requirement is guaranteed on all data points.

### SUMMARY

Various embodiments provide a method for determining quantum variables, computer program product and computer system as described by the subject matter of the independent claims. Advantageous embodiments are described in the dependent claims. Embodiments of the present invention can be freely combined with each other if they are not mutually exclusive.

In one aspect, the invention relates to a method for providing a quantum variable, comprising: providing a quantum register comprising a set of qubits defining a quantum system; representing states of the quantum system in a computational basis by an ordered set of consecutive nonnegative integer numbers, referred to as a set of indexes; determining a random variable in accordance with a predefined classical-quantum format, wherein the random variable is valued in a finite domain of classical values such that each value of the domain is derived from a respective index of the set of indexes through an affine relationship, the affine relationship being defined by a scaling factor and an offset factor; encoding the set of qubits to represent the random variable, wherein the encoding is performed such that the probability of measuring a state of the quantum system in the computational basis is the probability of observing (or obtaining) the domain value associated with the index representing said measured state when sampling the random variable.

In one aspect the invention relates to a computer program product comprising a computer-readable storage medium having computer-readable program code embodied therewith, the computer-readable program code configured to implement the method of the above embodiment.

In one aspect the invention relates to a computer system comprising a quantum register comprising a set of qubits defining a quantum system. The computer system is configured for: representing states of the quantum system in a computational basis by an ordered set of consecutive nonnegative integer numbers, referred to as a set of indexes; determining a random variable in accordance with a predefined classical-quantum format, wherein the random variable is valued in a finite domain of classical values such that each value of the domain is derived from a respective index of the set of indexes through an affine relationship, the affine relationship being defined by a scaling factor and an offset factor; encoding the set of qubits such that the probability of measuring a state of the quantum system in the computational basis is the probability of observing the domain value associated with the index representing said measured state when sampling the random variable.

In one aspect the invention relates to a computer system comprising a first quantum register, a second quantum register and an output quantum register, wherein the computer system is configured for performing the method of determining sum of two random variables as claimed in claim 6 or the method of multiplication of two random variables as claimed claim 13.

In one aspect, the invention relates to a method for providing a quantum variable. The method comprises: providing a quantum register comprising a set of qubits defining a quantum system; representing states of the quantum system in a computational basis by an ordered set of consecutive nonnegative integer numbers, referred to as a set of indexes; determining a set of ordered pairs, where a first element of each ordered pair is a complex number, such that the sum of all the squared absolute values of the complex numbers across the set equals one, and a second element of each pair is a real number in a finite domain of classical values, the real number being derived from a respective index of the set of indexes through an affine relationship, the affine relationship being defined by a scaling factor and an offset factor; encoding the set of qubits to represent the set of ordered pairs, wherein the encoding is performed such that the quantum state is the complex linear combination of states of the computational basis, where the coefficients of the linear combination are the first elements in the ordered pairs, and the states of the computational basis are represented by the respective indexes, each index being the index in the set of indexes associated to the respective second element of the ordered pair.

### BRIEF DESCRIPTION OF THE DRAWINGS

In the following embodiments of the invention are explained in greater detail, by way of example only, making reference to the drawings in which:

FIG. 1 is a block diagram of a computer system in accordance with an example of the present subject matter.

FIG. 2 is a flowchart of a method for determining a quantum variable in accordance with an example of the present subject matter.

FIG. 3 is a flowchart of a method for adding two quantum variables in accordance with an example of the present subject matter.

FIG. 4 is a flowchart of a method for determining weights for the addition of two random variables in accordance with an example of the present subject matter.

FIG. 5 is a flowchart of a method for determining weights for the addition of two random variables in accordance with an example of the present subject matter.

FIG. 6 is a flowchart of a method for multiplying two quantum variables in accordance with an example of the present subject matter.

FIG. 7 is a flowchart of a method for determining weights for the multiplication of two random variables in accordance with an example of the present subject matter.

FIG. 8 is a flowchart of a method for determining weights for the multiplication of two random variables in accordance with an example of the present subject matter.

FIG. 9 is a flowchart of a method for determining weights for the addition of two random variables in accordance with an example of the present subject matter.

FIGS. 10A and 10B are pseudocode of an algorithm for adding two quantum variables in accordance with an example of the present subject matter.

FIGS. 11A and 11B are_pseudocode of an algorithm for multiplying two quantum variables in accordance with an example of the present subject matter.

FIG. 12 is a computing environment in accordance with an example of the present subject matter.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The quantum system may refer to a system that is subject to the principles of quantum mechanics. A quantum system may be one or more qubits. The qubits of the quantum system may be part of one or more quantum registers. Quantum calculations may be performed by manipulating the qubits within the register(s). A property of the quantum systems may be the superposition which allows quantum particles to exist in multiple states of a given basis, simultaneously. In the following, an orthonormal basis for the quantum states of a quantum system may be referred to as the computational basis. For example, a qubit can be in a superposition of both the |0 [symbol] state and |1 [symbol] state at the same time. The state of the quantum system may be referred to herein as |z> where z is an integer represented by a binary string [z]₂ of length n, to mean the state |[z]₂> represents an n-qubit register, that is, the quantum system is defined by n qubits. For instance, the state |5 [symbol] is a compact representation of state |101 [symbol] on a 3-qubit register. Thus, the state of a quantum system may be represented by an integer z referred to herein as index or by a binary string [z]₂ which encode the integer z in the binary format e.g., the state |101 [symbol] of the 3-qubit register may be represented by the index 5 or by the binary string 101, where the index 5 is related to the binary string as follows: 5=1×2²+0×2¹+1×2⁰, where the coefficients (or binary coefficients) (z_{,0}=1, z_{,1}=0 and z_{,2}=1) of the powers of two are the elements of the binary string. All possible states of the quantum system may be represented by an ordered set of consecutive indexes. For example, the 3-qubit system has 8 possible states which may be represented by the set of 8 indexes 0, 1, 2, 3, 4, 5, 6 and 7.

The present subject matter may enable to represent the real numbers or integer numbers using quantum computing means. The real numbers may, for example, be floating point numbers. This representation may be performed by providing the random variable in a predefined format, herein referred to as classical-quantum format. The random variable in the classical-quantum format may be a quantum variable. The quantum variable may be defined by the quantum register of a given size which is equipped with the domain, and by an encoding function representing the affine relationship. The quantum variable may potentially further be defined by some additional classical properties. The quantum variable may, for example, be a structure that can contain one random variable at a time, as much as a classical variable is a cell containing one number at a time.

The random variable of the classical-quantum format may, for example, represent floating point numbers but it is not limited to. The random variable of the classical-quantum format may thus be referred to as classically enriched quantum floating- point variable (CEFV). In the following, and for simplification of the description, the random variable of the classical-quantum format defined according to the present subject matter may be referred to as CEFV variable, but it is not limited to as types other than floating point numbers may be represented by the random variable. Providing the CEFV variable in accordance with the present subject matter may mean that the quantum register (after encoding of its qubits) represents the CEFV variable.

The definition of the CEFV variable according to the present subject matter may comprise multiple steps. In particular, the quantum register comprising the set of qubits may be provided (in step S1). The set of qubits may, for example, comprise a number n of qubits. The number n of qubits may, for example, be a predefined number. Alternatively, the number n of qubits may be defined based on the CEFV variable to be defined e.g., the maximum value of the CEFV variable may be used to define the number n of qubits. In other words, the size of the CEFV variable may dictate the size of the provided quantum register or the size of the quantum register dictate the size of the CEFV variable. The set of qubits may define a quantum system. The total number N of states in the computational basis of the quantum system may be two to the power of n, i.e., N=2ⁿ. The states of the quantum system may, for example, be the states of the quantum system in a computational basis. For example, a single qubit may be in the states |0> and |1> representing the number 0 and 1 respectively. For the set of n qubits, the computational basis may be defined as the tensor product space of the individual qubit states. The states of the computational basis of the quantum system (in step S2) may be represented by an ordered set of consecutive nonnegative integer numbers. For example, the ordered set of consecutive nonnegative integer numbers may start from zero but it is not limited to this starting point as the skilled person may start from other values. The ordered set of consecutive nonnegative integer numbers may be referred to as the set of indexes respectively. The states of the computational basis of the quantum system may, for example, be represented by the integer variable z. For example, for each state S of the computational basis states of the quantum system, the integer variable z may have one number of the set of nonnegative integer numbers {0, . . . , 2ⁿ−1} that corresponds to said state S, z∈{0, . . . , 2ⁿ−1}. The CEFV variable may be valued (in step S3) in a finite domain whose size is equal to the number N of states of the computational basis of the quantum system. The domain may comprise a set of N values, where each value of the domain may be obtained by the affine relationship. The affine relationship may be an affine equation. The affine relationship may be defined by the scaling factor and the offset factor. The affine relationship may, for example, be defined as a+bz, where a is the offset factor and b is the scaling factor. This may provide a classical contribution as well as quantum contribution to the CEFV variable. The scaling factor may, for example, be a nonzero real number. The offset factor may, for example, be a real number. The quantum contribution may be provided by the integer variable z that represents one of the quantum states of the computational basis of the quantum system. The classical contribution may be provided by the offset factor and the scaling factor. The definition of the CEFV variable may further involve an encoding step (S4). In the encoding step, the set of qubits may be encoded such that the probability of measuring a state of the quantum system in the computational basis is the probability of observing the domain value associated with the index z representing said measured state when sampling the CEFV variable. That is, the set of qubits may be encoded such that the probability of measuring a state of the quantum system in the computational basis is the probability of obtaining the domain value associated with the index z representing said measured state, wherein the domain value is obtained by sampling the CEFV variable. The encoding may, for example, be an amplitude encoding or other types of encoding.

For example, a CEFV variable X which is supported in the domain {a+b0, . . . , a+b(N−1)} may be encoded with the global quantum state

$$\vert ψ > := {\sum }_{z = 0}^{N - 1} \sqrt{{p}_{z}} \vert z >$$

which is a superposition of individual states |z> of the computational basis, where p_{z}= [symbol] (X=a+bz), where p_{z} is the probability of obtaining individual state |z> after measuring the state |ψ>, where [symbol] (X=a+bz) is the probability of obtaining a+bz after sampling the variable X. The individual state of the quantum system is referred to as |z> where z is an index that can be represented by a binary string [z]₂ of length n, to mean that the state |z> can be represented (in binary format) as |[z]₂>. For example, each qubit of the set of qubits may be associated with a respective position in the binary string.

Thus, the present subject matter may provide a quantum-classical hybrid representation of numbers, which may include a classical register storing global information such as data ranges, the sign and the approximation bounds. The currently defined CEFV variables may reduce the circuit depth e.g., by up to 89%, against previous techniques for circuits that calculate the sum. Indeed, the provided CEFV variables may be used to evaluate one or more functions, thus allowing quantum computers to tackle data transformations of arbitrary complexity, as long as the circuit depth and width are sustained by the hardware. The CEFV variable may be used to build functions, and then integrate these functions in full quantum workloads that solve end-to-end problems. For example, in the domain of finance, in option pricing, the CEFV variables may be used to represent payoffs resulting from elaborate calculations.

The value of the CEFV variable may provide an approximation of a respective classical domain value e.g., the CEFV variable value may be equal to exactly the classical domain value or equal to, within an error, the domain value. The present subject matter may control the level of these errors by determining the CEFV variables using tolerance ranges. For that and according to one example, the definition of the CEFV variable may further comprise: determining a tolerance range. The set of qubits may be encoded such that an approximate value of each domain value of the domain {a+b0, . . . , a+b(N−1)} may be represented with the same quantum state as the domain value in case the difference between the domain value and the approximate value is within the tolerance range. For example, the tolerance range may be defined as the range [−ϵ⁻, ϵ⁺], where ϵ⁻ and ϵ⁺ may be below and above errors, ϵ⁻∈[0, +∞) and ϵ⁺∈[0, +∞). Providing the errors ϵ⁻ and ϵ⁺ may further be advantageous as it may enable to keep track of the error propagation, in particular, as the computation of the sum and the product may be done up to a rounding error.

Hence, the definition of the CEFV variable may involve a tuple of three entries namely the quantum register, the domain of values of the CEFV variable and the affine relationship. This tuple of three entries may be referred to as CEFV 3-tuple. Optionally, the tuple may contain two additional entries representing the two limits of the tolerance range respectively. This tuple of five entries may be referred to as CEFV 5-tuple. The CEFV variable may, for example, be used to perform statistical analysis (e.g., for option pricing) whose results may be used to control the operations of technical systems.

The present subject matter may enable access to more than one random variable by repeating the above definition method. This may enable to store higher amount of data. According to one example, a first CEFV variable and a second CEFV variable may be defined using the above definition. That is, steps S1 through S4 may be performed twice in order to define the first CEFV variable and a second CEFV variable.

For that, a first quantum register comprising a first set of qubits may be provided. The first set of qubits may, for example, comprise a number n₁ of qubits. The number n₁ of qubits may, for example, be a predefined number. Alternatively, the number n₁ of qubits may be defined based on the first CEFV variable to be defined e.g., the maximum value of the first CEFV variable may be used to define the number n₁ of qubits. In other word, the size of the first CEFV variable may define the size of the provided first quantum register or the size of the first quantum register defines the size of the first CEFV variable. The total number N₁ of states of the computational basis of the first quantum system may thus be two to the power of n₁, i.e., N₁=2ⁿ^{₁}. The states of the computational basis of the first quantum system may be represented by an ordered set of consecutive first indexes. For example, the ordered set of consecutive first indexes may start from zero but it is not limited to this starting point as the skilled person may start from other values. The states of the computational basis of the first quantum system may, for example, be represented by the integer variable z₁, where for each state St1 of the first quantum system, the integer variable z₁ may have one number of the set of first indexes {0, . . . , 2ⁿ^{₁}−1} that corresponds to said state St1, z₁∈{0, . . . , 2ⁿ^{₁}−1}. The first CEFV variable may be valued in a finite first domain whose size is equal to the number N₁ of states of the computational basis of the first quantum system. The first domain may comprise a set of N₁ values, where each value of the first domain may be obtained by a first affine relationship. The first affine relationship may be defined by a first scaling factor and a first offset factor. The first affine relationship may, for example, be defined as a₁+b₁z₁, where a₁ is the first offset factor and b₁ is the first scaling factor. This may provide a classical contribution as well as quantum contribution to the first CEFV variable. The quantum contribution may be provided by the integer variable z₁ that represents one of the quantum states of the computational basis of the first quantum system. The first set of qubits may be encoded in order to represent the first CEFV variable. The first scaling factor may, for example, be a nonzero real number. The first offset factor may, for example, be a real number.

Thus, the definition of the first CEFV variable may involve a first CEFV 3-tuple of three entries namely comprising the first quantum register, the first domain of values of the first CEFV variable and the first affine relationship.

A second quantum register comprising a second set of qubits may be provided. The second set of qubits may, for example, comprise a number n₂ of qubits. The number n₂ of qubits may, for example, be a predefined number. Alternatively, the number n₂ of qubits may be defined based on the second CEFV variable to be defined e.g., the maximum value of the second CEFV variable may be used to define the number n₂ of qubits. In other word, the size of the second CEFV variable may define the size of the provided second quantum register or the size of the second quantum register may define the size of the second CEFV variable. The total number N₂ of states of the computational basis of the second quantum system may thus be two to the power of n₂, i.e., N₂=2ⁿ^{₂}. The states of the computational basis of the second quantum system may be represented by an ordered set of consecutive second indexes. For example, the ordered set of consecutive second indexes may start from zero but it is not limited to this starting point as the skilled person may start from other values. The states of the computational basis of the second quantum system may, for example, be represented by the integer variable z₂, where for each state St2, the integer variable z₂ may have one number of the set of second indexes {0, . . . , 2ⁿ^{₂}−1} that corresponds to said state St2, z₂∈{0, . . . , 2ⁿ^{₂}−1}. The second CEFV variable may be valued in a finite second domain whose size is equal to the number N₂ of states of the computational basis of the second quantum system. The second domain may comprise a set of N₂ values, where each value of the second domain may be obtained by a second affine relationship. The second affine relationship may be defined by a second scaling factor and a second offset factor. The second affine relationship may, for example, be defined as a₂+b₂z₂, where a₂ is the second offset factor and b₂ is the second scaling factor. This may provide a classical contribution as well as quantum contribution to the second CEFV variable. The quantum contribution may be provided by the integer variable z₂ that represents one of the quantum states of the computational basis of the first quantum system. The second set of qubits may be encoded in order to represent the second CEFV variable. The second scaling factor may, for example, be a nonzero real number. The second offset factor may, for example, be a real number.

Thus, the definition of the second CEFV variable may involve a second CEFV 3-tuple of three entries namely comprising the second quantum register, the second domain of values of the second CEFV variable and the second affine relationship.

In one encoding example, the first set of qubits and the second set of qubits may be encoded such that the state of the overall system formed by the two sets of qubits may not be separable as two states, as an effect of the quantum property of entanglement. In this case, the probability of measuring a state of a joint quantum system of the first and second quantum systems in the computational basis is the probability of jointly observing the first domain value associated with the first index representing said measured state when sampling the first random variable and the second domain value associated with the second index representing said measured state when sampling the second random variable. In formulas, the overall state |ψ> may be decomposed as

$$\vert ψ > := {\sum }_{{z}_{1} = 0}^{{N}_{1} - 1} \sqrt{{p}_{{z}_{1} , {z}_{2}}} \vert {z}_{1} > \vert {z}_{2} >$$

where p_{z}_{₁}_{,z}_{₂}= [symbol] (X₁=a₁+b₁z₁, X₂=a₂+b₂z₂). This may enable to provide the first CEFV variable and second CEFV variable as dependent variables.

In one encoding example, the first set of qubits may be encoded such that the state of the overall system formed by the two sets of qubits is separable as the tensor product of two states, each representing one set of qubits. In formulas, the overall state |ψ> may be decomposed as |ψ>=|ψ₁>|ψ₂>. In this case, the probability of measuring a state of the first quantum system in the computational basis is the probability of observing the first domain value associated with the first index representing said measured state when sampling the first random variable. The second set of qubits may be encoded such that the probability of measuring a state of the second quantum system in the computational basis is the probability of observing the second domain value associated with the second index representing said measured state when sampling the second random variable. In formulas,

$$\vert {ψ}_{1} > := {\sum }_{{z}_{1} = 0}^{{N}_{1} - 1} \sqrt{{p}_{{z}_{1}}} \vert {z}_{1} >$$

where p_{z}_{₁}= [symbol] (X₁=a₁+b₁z₁) and

$$\vert {ψ}_{2} > := {\sum }_{{z}_{2} = 0}^{{N}_{2} - 1} \sqrt{{p}_{{z}_{2}}} \vert {z}_{2} > ,$$

where p_{z}_{₂}= [symbol] (X₂=a₂+b₂z₂). This may enable to provide the first CEFV variable and second CEFV variable as independent variables.

### Addition of CEFV Variables

The present subject matter may further be advantageous as it may equipe the CEFV variables with basic operations such as addition and multiplication operations that may be performed without overflow. The present subject matter may make use of the hybrid format of the CEFV variables to perform the sum efficiently. For example, to sum two CEFVs variables, the offset factors may be summed together with a classical computer, while quantum states may be processed by a quantum circuit that keeps into account the two scaling factors.

According to one first addition example, adding the first CEFV variable and the second CEFV variable comprises: providing an output quantum register comprising a third set of qubits, thereby defining a third quantum system. The first quantum system, second quantum system and third quantum system may form a joint or composite quantum system. A first set of weights may be determined for the first set of qubits respectively. A second set of weights may be determined for the second set of qubits respectively. The first set of weights and the second set of weights are determined such that the output quantum register after applying the sum algorithm represents a third random variable of the classical-quantum format, so that the third random variable is a (possibly approximate) representation of the sum of the first and second random variables. The third CEFV variable may be defined by a CEFV 3-tuple or by a CEFV 5-tuple. A polynomial may be defined. The polynomial may be the sum of monomials, wherein each monomial is associated with respective qubit of the first set of qubits and second set of qubits, wherein each monomial is defined as the product of an unknown and a weight associated with the respective qubit. A unitary quantum transformation that is configured to act on the first quantum register and the second quantum register, on the output quantum register, and on an auxiliary register may be generated in order to evaluate the polynomial into the output quantum register. The unitary transformation may be applied on the first and second quantum registers. This may result in encoding the third set of qubits such that the states of the computational basis of the third quantum system represent values of the third random variable of the classical-quantum format. The auxiliary register may, for example, comprise a set of qubits used for internal calculations for the evaluation of the unitary transformation, e.g., the auxiliary register may be used as a temporary memory, by the unitary transformation and then restored to the original |0> state (namely, freed for other usages). The unknown may, for example, be a variable.

This example may be advantageous as it may enable to perform the sum using classical and quantum computing. In addition, the resulting sum also represents a random variable according to the classical-quantum format of the present subject matter.

The first addition example may, for example, be described using the following notations. The output quantum register may comprise a number nₒᵤₜ of qubits. The number nₒᵤₜ of qubits may, for example, be a predefined number. Alternatively, the number nₒᵤₜ of qubits may be iteratively defined as described below. The total number Nₒᵤₜ of states of the computational basis of the third quantum system may thus be two to the power of nₒᵤₜ, i.e., Nₒᵤₜ=2ⁿ^{ₒᵤₜ}. Any pair of a state of the computational basis of the first set of qubits and a state of the computational basis of the second set of qubits may be represented respectively by the pair (z₁, z₂) of first index z₁ and second index z₂, where z₁∈{0, . . . , 2ⁿ^{₁}−1} and z₂∈{0, . . . , 2ⁿ^{₂}−1}. The first index z₁ may be represented in a binary format as follows:

$${z}_{1} = {\sum }_{{j}_{1} = 0}^{{n}_{1} - 1} {z}_{1 , {j}_{1}} {2}^{{j}_{1}} ,$$

where z_{1,j}_{₁}∈{0,1} may represent one respective qubit of the first set of qubits. For example, each qubit of the first set of qubits may be associated with a respective position in the binary string [z₁]₂. The second index z₂ may be represented in a binary format as follows:

$${z}_{2} = {\sum }_{{j}_{2} = 0}^{{n}_{2} - 1} {z}_{2 , {j}_{2}} {2}^{{j}_{2}} ,$$

where z_{2,j}_{₂}∈{0,1} may represent one respective qubit of the second set of qubits. For example, each qubit of the second set of qubits may be associated with a respective position in the binary string [z₂]₂. The first set of weights may be referred to as

$${[ {w}_{1 , {j}_{1}} ]}_{{j}_{1} = 0}^{{n}_{1} - 1} ,$$

where each weight is associated with a respective qubit of the first set of qubits. The second set of weights may be referred to as

$${[ {w}_{2 , {j}_{2}} ]}_{{j}_{2} = 0}^{{n}_{2} - 1} ,$$

where each weight is associated with a respective qubit of the second set of qubits. The polynomial p(z₁, z₂) may, for example, be obtained by the following sum in binary format:

$$p ( {z}_{1} , {z}_{2} ) = {\sum }_{{j}_{1} = 0}^{{n}_{1} - 1} {z}_{1 , {j}_{1}} {w}_{1 , {j}_{1}} + {\sum }_{{j}_{2} = 0}^{{n}_{2} - 1} {z}_{2 , {j}_{2}} {w}_{2 , {j}_{2}} .$$

This may provide an equation that represents every pair of qubits of the first set of qubits and the second set of qubits. Each individual product of the products z_{1,j}_{₁}w_{1,j}_{₁} in the polynomial defines a monomial of the polynomial, and each individual product of the products z_{2,j}_{₂}w_{2,j}_{₂} is a monomial of the polynomial, where each of the unknowns z_{1,j}_{₁} represents a binary coefficient and is associated with a respective qubit of the first set of qubits and each of the unknowns z_{2,j}_{₂} represents a binary coefficient and is associated with a respective qubit of the second set of qubits. The unitary transformation may be generated for the defined polynomial p(z₁, z₂). The unitary transformation may be implemented using a quantum circuit. The unitary transformation may, for example, be generated using the method described in the paper: R. Seidel, N. Tcholtchev, S. Bock, C. K.-U. Becker, and M. Hauswirth, “Efficient Floating Point Arithmetic for Quantum Computers,” IEEE Access, vol. 10, pp. 72400-72415, 2022.

According to one example implementation of the first addition example, the states of the third quantum system represent values of the third random variable of the classical-quantum format through a third affine relationship defined by a third scaling factor and a third offset factor, wherein the third offset factor is the classical sum of the first offset factor and second offset factor and the third scaling factor is the product of an alignment scale and a predefined target scale, wherein the alignment scale is the inverse of a power of two such that the sum can be performed without overflow. The target scale may, for example, be a user-defined scale e.g., the target scale may be received as input from the user. The alignment scale may, for example, be automatically determined. For example, the third offset factor may be referred to as aₒᵤₜ. The third scaling factor may be referred to as bₒᵤₜ. This example may enable to obtain the third offset factor as the sum of the first offset factor and the second offset factor, that is aₒᵤₜ=a₁+a₂ and the third scaling factor may be provided as the product of the target scale b_{lead} and the alignment scale b_{scale}, that is bₒᵤₜ=b_{scale}b_{lead}. The states of the computational basis of the third quantum system may, for example, be represented by the integer variable zₒᵤₜ, where for each state St3 of the third quantum system, the integer variable zₒᵤₜ may have one number of the set of indexes {0, . . . , 2ⁿ^{ₒᵤₜ}−1} that corresponds to the state St3, zₒᵤₜ∈{0, . . . , 2ⁿ^{ₒᵤₜ}−1}.

This example may be advantageous because, without executing the CEFV variable definition method, the sum algorithm enables to obtain this classical-quantum format variable. This example implementation may be automatically executed, and thus the third scaling factor and the third offset factor for the output of the sum may automatically be determined. As a consequence, the no-overflow can be guaranteed automatically.

In one example implementation of the first addition example, the first set of weights and the second set of weights may be determined such that the output quantum register, after performing the sum of the first CEFV variable and the second CEFV variable, represents a third CEFV variable which encodes an approximation of the sum of the two input variables without overflow. For that, the first set of weights and the second set of weights may be chosen such that the sum of the absolute value of the weights in the first set of weights and in the second set of weights is smaller than or equal to the maximal index 2ⁿ^{ₒᵤₜ}−1 of the output quantum register. Each weight of the first set of weights and second set of weights may be an integer number. A rounding may be applied to the weight to make sure that the resulting weight is an integer number. The maximal index 2ⁿ^{ₒᵤₜ}−1 is provided with the minus one term because the indexes are nonnegative integers, meaning that the indexing of the output quantum register starts from zero and ends with the maximal index of 2ⁿ^{ₒᵤₜ}−1.

In one example implementation of the first addition example, the first set of weights and the second set of weights may be determined such that the output quantum register, after performing the sum of the first CEFV variable and the second CEFV variable would represent a third CEFV variable which encodes an approximation of the sum of the two input variables without overflow. For that, the first set of weights w_{1,j}_{₁} may be up to some factor and rounding equal to 2^{j}^{₁}/bₒᵤₜ and the second set of weights w_{2,j}_{₂} may be up to some factor and rounding equal to 2^{j}^{₂}/bₒᵤₜ. That is, each weight of the first set of weights and second set of weights before rounding may be proportional to the inverse of the third scaling factor, w_{1,j}_{₁}∝1/bₒᵤₜ and w_{2,j}_{₂}∝1/bₒᵤₜ. In addition, each weight of the first set of weights before rounding may include (2^{j}^{₁}) two to the power of the position (j₁) of the associated qubit of the weight. Each weight of the second set of weights before rounding may include (2^{j}^{₂}) two to the power of the position (j₂) of the associated qubit of the weight. In this example, the third scaling factor bₒᵤₜ may be changed one or more times until the sum of the absolute value of the weights becomes smaller than or equal to the maximal index 2ⁿ^{ₒᵤₜ}−1 of the output quantum register.

The value of the third CEFV variable may be equal to, within an error, the corresponding classical sum of the first and second domain values of the first and second CEFV variables. In addition to controlling the overflow, the present subject matter may control the level of these errors. For that, in one example implementation of the first addition example, the first set of weights and the second set of weights may be determined such that the output quantum register, after performing the sum of the first CEFV variable and the second CEFV variable, represents a third CEFV variable which is defined by a CEFV 5-tuple. That is, the third CEFV variable is associated with a tolerance range so that the same state of the output quantum register is associated with variables that are within the range. This may enable to approximate the sum within (controlled) tolerances specified for the output.

In one example implementation of the first addition example, the first set of weights and the second set of weights may be determined such that the output quantum register, after performing the sum of the first CEFV variable and the second CEFV variable, represents a third CEFV variable, wherein the first set of weights may be provided as follows: w_{1,j}_{₁} is the closest-integer rounding of 2^{j}^{₁}b₁/bₒᵤₜ and the second set of weights may be provided as follows: w_{2,j}_{₂} is the closest-integer rounding of 2^{j}^{₂}b₂/bₒᵤₜ.

According to one example implementation of the first addition example, the alignment scale is equal to the inverse of two to the power of an integer M (b_{scale}=2^{-M}), where M may, for example, be the highest integer so that the sum

$$( i . e . , {\sum }_{{j}_{1} = 0}^{{n}_{1} - 1} \vert {w}_{1 , {j}_{1}} \vert + {\sum }_{{j}_{2} = 0}^{{n}_{2} - 1} \vert {w}_{2 , {j}_{2}} \vert )$$

of the absolute value of the weights in the first set of weights and in the second set of weights is smaller than or equal to the maximal index 2ⁿ^{ₒᵤₜ}−1 of the output quantum register. This may, for example, enable to obtain the third scaling factor as follows: bₒᵤₜ=2^{-M}b_{lead}, where b_{scale}=2^{-M}. The integer number M is the highest integer number whose associated weights w_{1,j}_{₁} and w_{2,j}_{₂} fulfil the condition:

$${\sum }_{{j}_{1} = 0}^{{n}_{1} - 1} \vert {w}_{1 , {j}_{1}} \vert + {\sum }_{{j}_{2} = 0}^{{n}_{2} - 1} \vert {w}_{2 , {j}_{2}} \vert \leq {2}^{{n}_{out}} - 1.$$

In one example implementation of the first addition example, the integer number M may be initialized as follows:

$$M ← ⌈ {log}_{2} ( \text{?} - 1 ) - {log}_{2} ( ( \text{?} - 1 ) \vert \frac{{b}_{1}}{\text{?}} \vert + ( \text{?} - 1 ) \vert \frac{{b}_{2}}{\text{?}} \vert ) ⌉$$

$$\text{?} \text{indicates text missing or illegible when filed}$$

and then changed one or more times to obtain the highest integer number such that the associated weights fulfil the condition:

$$\\ {\sum }_{{j}_{1} = 0}^{{n}_{1} - 1} \vert {w}_{1 , {j}_{1}} \vert + {\sum }_{{j}_{2} = 0}^{{n}_{2} - 1} \vert {w}_{2 , {j}_{2}} \vert \leq {2}^{{}_{} {n}_{out}} - 1.$$

Alternatively, the integer number M may be initialized with any other integer such as an integer that is obtained from a previous execution of the first addition example and then changed one or more times to obtain the highest integer such that the associated weights fulfil the condition:

$$\\ {\sum }_{{j}_{1} = 0}^{{n}_{1} - 1} \vert {w}_{1 , {j}_{1}} \vert + {\sum }_{{j}_{2} = 0}^{{n}_{2} - 1} \vert {w}_{2 , {j}_{2}} \vert \leq {2}^{{}_{} {n}_{out}} - 1.$$

According to one example implementation of the first addition example, the first set of weights and the second set of weights may be defined using an iterative method. In step aa1) a current value of the first and second sets of weights may be provided. The first and second sets of weights may be randomly set, making sure that each of the first and second sets of weights is an integer. In step bb1) the sum of the absolute value of the weights in the first and second sets of weights may be performed. In step cc1) it may be determined whether the sum is smaller than or equal to the maximal index 2ⁿ^{ₒᵤₜ}−1 of the output quantum register. In step dd1) in case the sum is higher than the maximal index 2ⁿ^{ₒᵤₜ}−1, steps aa1) to bb1) may be repeated (e.g., trying other values for the first and second sets of weights). In step ee1) the last determined first and second sets of weights may be provided.

In one example, after providing the first set and second set of weights in step ee1), the number of qubits of the output quantum register may be lowered to the power of the closest number of the sum, wherein the closest number is a power of two. For example, the last provided weights may fulfill the inequality:

$$\\ {\sum }_{{j}_{1} = 0}^{{n}_{1} - 1} \vert {w}_{1 , {j}_{1}} \vert + {\sum }_{{j}_{2} = 0}^{{n}_{2} - 1} \vert {w}_{2 , {j}_{2}} \vert \leq {2}^{{}_{} {n}_{out}} - 1.$$

This means that there may be a gap of values between the sum

$$\\ {\sum }_{{j}_{1} = 0}^{{n}_{1} - 1} \vert {w}_{1 , {j}_{1}} \vert + {\sum }_{{j}_{2} = 0}^{{n}_{2} - 1} \vert {w}_{2 , {j}_{2}} \vert$$

and the maximal index 2ⁿ^{ₒᵤₜ}−1. The smallest value in this gap which is a power of two (2^{s}) may be selected and the number of qubits nₒᵤₜ may be replaced by the power s of the selected number. Alternatively, in case (in step cc1) it is determined that the sum is smaller than or equal to the maximal index 2ⁿ^{ₒᵤₜ}−1 of the output quantum register, the number of qubits of the output quantum register may be repeatedly lowered (e.g., by one), wherein for each lowering: steps aa1) to cc1) may be performed, wherein the repetition is performed as long as the sum is smaller than or equal to the maximal index 2ⁿ^{ₒᵤₜ}−1 of the output quantum register associated with the lowered number.

An example implementation of the sum may be described as follows. For example, the first quantum register comprises one qubit and the second quantum register comprises one qubit, e.g., n₁=1 and n₂=1. The first offset factor and the second offset factor are equal to zero, a₁=0 and a₂=0. The first scaling factor is the target scale, b₁=b_{lead} and the second scaling factor is equal to ⅓, b₂=⅓. The output quantum register may comprise four qubits, nₒᵤₜ=4. The first quantum register contains state |z1 [symbol] =|1 [symbol] , as a representation of the floating point number 1, and the second quantum register contains state |z2 [symbol] =|1 [symbol] , as a representation of ⅓. The sum may be expected to be an approximation of 4/3. The number of qubits in the output quantum register is nₒᵤₜ=4, as one may need as many digits as possible to accurately represent a repeating binary fraction, constrained by nₒᵤₜ≤nₘₐₓ. The iterative method may start with M=4, in which case

$$\\ {w}_{1} = [ {2}^{{}_{} 4} ] = [ 16 ] , {w}_{2} = [ rnd ( \frac{{2}^{{}_{} 4}}{3} ) ] = [ rnd ( \frac{16}{3} ) ] = [ 5 ] ,$$

where rnd denotes the rounding. Square brackets are kept to emphasize that in the more general case of many input qubits, w₁ and w₂ would be vectors. Such weights do not respect the exit inequality condition si-e 16+5>2⁴−1. Therefore, M is decreased to 3, and

$$\\ {w}_{1} = [ {2}^{{}_{} 3} ] = [ 8 ] , {w}_{2} = [ rnd ( \frac{{2}^{{}_{} 3}}{3} ) ] = [ rnd ( \frac{8}{3} ) ] = [ 3 ] = [ 1 + 2 ] .$$

$$\\ {w}_{2} = [ 1 + 2 ]$$

means that the (only) digit in the second quantum register affects both the last and second-to-last result qubit in the output quantum register, namely the third and fourth result digit respectively. The calculation outcome then writes

$$\\ {2}^{{}_{} - M} {b}_{lead} ( {w}_{1 , 0} {z}_{1 , 0} + {w}_{2 , 0} {z}_{2 , 0} ) = 1 + \frac{1 + 2}{8} ,$$

so that ⅓ has been converted into

$$\\ \frac{1 + 2}{8} ,$$

that is its best representing fraction given the number of available qubits.

### Multiplication of CEFV Variables

For simplification of the description, the same names and variables which are used to describe the sum of two variables are used to describe the multiplication of two variables. For example, the size of the output quantum register is nₒᵤₜ, the third scaling factor is bₒᵤₜ and the third offset factor is aₒᵤₜ are similarly noted but they are clearly different taking into account their application context namely the sum or multiplication.

According to one first multiplication example, the multiplication of the first random variable and second random variable comprises: providing an output quantum register comprising a third set of qubits, thereby defining a third quantum system, the first, second and third quantum systems forming a joint quantum system. A determination of a first set of weights for the first set of qubits respectively, a second set of weights for the second set of qubits respectively and a third set of qubits for the pairs of qubits of the first set and second set of qubits respectively may be performed. The determining of the three sets of weights may be performed such that the output quantum register after performing the multiplication represents a third random variable of the classical-quantum format. A polynomial may be defined. The polynomial may be defined as a sum of first degree monomials and second degree monomials. Each first degree monomial is associated with respective qubit of the first set of qubits and the second set of qubits. Each first degree monomial is defined as the product of an unknown and a weight associated with the respective qubit. Each second degree monomial is associated with a respective pair of qubits of the first and second sets of qubits, wherein each second degree monomial is defined as the product of a weight associated with the pair of qubits, and two unknowns, respectively associated with a qubit of the first set and a qubit of the second set of qubits. A unitary quantum transformation that is configured to act on the first quantum register and second quantum register, on the output quantum register, and on an auxiliary register may be generated in order to evaluate the polynomial into the output quantum register. The unitary transformation may be applied on the first and second quantum registers, thereby encoding the third set of qubits such that the state of the computational basis of the third quantum system represents values of a third random variable of the classical-quantum format.

This example may be advantageous as it may enable to perform the multiplication using classical and quantum computing. In addition, the resulting product also represents a random variable according to the classical-quantum format of the present subject matter.

The first multiplication example may, for example, be described using the following notations. The output quantum register may comprise a number nₒᵤₜ of qubits. The number nₒᵤₜ of qubits may, for example, be a predefined number. Alternatively, the number nₒᵤₜ of qubits may be iteratively defined as described below. The total number Nₒᵤₜ of states of the computational basis of the third quantum system may thus be two to the power of nₒᵤₜ, i.e., Nₒᵤₜ=2ⁿ^{ₒᵤₜ}. Any pair of a state of the first set of qubits and a state of the second set of qubits may be represented respectively by the pair (z₁, z₂) of first index z₁ and second index z₂, where z₁∈{0, . . . , 2ⁿ^{₁}−1} and z₂∈{0, . . . , 2ⁿ^{₂}−1}. The first index z₁ may be represented in a binary format as follows:

$$\\ {z}_{1} = {\sum }_{{j}_{1} = 0}^{{n}_{1} - 1} {z}_{1 , {j}_{1}} {2}^{{}_{} {j}_{1}} ,$$

where z_{1,j}_{₁}∈{0,1} may represent one respective qubit of the first set of qubits. For example, each qubit of the first set of qubits may be associated with a respective position in the binary string [z₁]₂. The second index z₂ may be represented in a binary format as follows:

$$\\ {z}_{2} = {\sum }_{{j}_{2} = 0}^{{n}_{2} - 1} {z}_{2 , {j}_{2}} {2}^{{}_{} {j}_{2}} ,$$

where z_{2,j}_{₂}∈{0,1} may represent one respective qubit of the second set of qubits. For example, each qubit of the second set of qubits may be associated with a respective position in the binary string [z₂]₂. The first set of weights may be referred to as

$$\\ {[ {w}_{1 , {j}_{1}} ]}_{{j}_{1} = 0}^{{n}_{1} - 1} ,$$

where each weight is associated with a respective qubit of the first set of qubits. The second set of weights may be referred to as

$$\\ {[ {w}_{2 , {j}_{2}} ]}_{{j}_{2} = 0}^{{n}_{2} - 1} ,$$

where each weight is associated with a respective qubit of the second set of qubits. The third set of weights may be referred to as

$$\\ {[ {w}_{prod , {j}_{1} + {j}_{2}} ]}_{{j}_{1} = 0 , {j}_{2} = 0}^{{n}_{1} - 1 , {n}_{2} - 1} ,$$

where each weight is associated with a respective pair of qubits (j₁, j₂) of the first set of qubits and the second set of qubits. The polynomial p(z₁, z₂) may, for example, be obtained by the following sum in binary format:

$$\\ p ( {z}_{1} , {z}_{2} ) = {\sum }_{{j}_{1} = 0}^{{n}_{1} - 1} {z}_{1 , {j}_{1}} {w}_{1 , {j}_{1}} + {\sum }_{{j}_{2} = 0}^{{n}_{2} - 1} {z}_{2 , {j}_{2}} {w}_{2 , {j}_{2}} + {\sum }_{{j}_{1} = 0}^{{n}_{1} - 1} {\sum }_{{j}_{2} = 0}^{{n}_{2} - 1} {z}_{1 , {j}_{1}} {z}_{2 , {j}_{2}} {w}_{prod , {j}_{1} + {j}_{2}} .$$

This may provide an equation that represents every pair of qubits of the first set of qubits and the second set of qubits. Each product of the products z_{1,j}_{₁}w_{1,j}_{₁} in the polynomial defines a first degree monomial of the polynomial, and each product of the products z_{2,j}_{₂}w_{2,j}_{₂} is a first degree monomial of the polynomial, where each of the unknowns z_{1,j}_{₁} represents a binary coefficient and is associated with a respective qubit of the first set of qubits and each of the unknowns z_{2,j}_{₂} represents a binary coefficient and is associated with a respective qubit of the second set of qubits. Each product of the products z_{1,j}_{₁}z_{2,j}_{₂}w_{prod,j}_{₁}₊ⱼ_{₂} is a second degree monomial of the polynomial, where each of the z_{1,j}_{₁}z_{2,j}_{₂} is the product of two unknowns, respectively associated with a qubit of the first set of qubits and a qubit of the second set of qubits. The unitary transformation may be generated for the defined polynomial p(z₁, z₂). The unitary transformation may be implemented using a quantum circuit. The unitary transformation may, for example, be generated using the method described in the paper: R. Seidel, N. Tcholtchev, S. Bock, C. K.-U. Becker, and M. Hauswirth, “Efficient Floating Point Arithmetic for Quantum Computers,” IEEE Access, vol. 10, pp. 72400-72415, 2022.

This example may enable to obtain the third offset factor as the product of the first offset factor and the second offset factor, that is aₒᵤₜ=a₁a₂ and the third scaling factor may be the target scale. The states of the computational basis of the third quantum system may, for example, be represented by the integer variable zₒᵤₜ, where for each state St4, the integer variable zₒᵤₜ may have one number of the set of indexes {0, . . . , 2ⁿ^{ₒᵤₜ}−1} that corresponds to the each state St4, zₒᵤₜ∈{0, . . . , 2ⁿ^{ₒᵤₜ}−1}.

According to one example implementation of the first multiplication example, the states of the computational basis of the third quantum system may represent values of the third random variable of the classical-quantum format through a third affine relationship defined by a third scaling factor and a third offset factor, wherein the third offset factor is the classical product of the first and second offsets and the third scaling factor is a predefined target scale. This example implementation may be automatically executed, and thus the third scaling factor and the third offset factor for the output of the product may automatically be determined. As a consequence, the no-overflow can be guaranteed automatically.

According to one example, each weight comprises an alignment scale, wherein the alignment scale is equal to the inverse of two to the power of an integer M, where M is the highest integer so that the sum

$$\\ ( i . e . , {\sum }_{{j}_{1} = 0}^{{n}_{1} - 1} \vert {w}_{1 , {j}_{1}} \vert + {\sum }_{{j}_{2} = 0}^{{n}_{2} - 1} \vert {w}_{2 , {j}_{2}} \vert + {\sum }_{{j}_{1} = 0}^{{n}_{1} - 1} {\sum }_{{j}_{2} = 0}^{{n}_{2} - 1} \vert {w}_{prod , {j}_{1} + {j}_{2}} \vert )$$

of the absolute value of the weights in the first set of weights and in the second set of weights and in the third set of weights is smaller than or equal to the maximal index 2ⁿ^{ₒᵤₜ}−1 of the output quantum register, wherein the alignment scale is provided such that the product can be performed without overflow.

This example may be advantageous because without executing the CEFV variable definition method, the way the product is performed enables to “preserve” this classical-quantum format variable.

According to one example implementation of the first multiplication example, the integer number M may, for example, be defined as follows:

$$M ← ⌈ {log}_{2} 2 \text{?} - 1 ) - {log}_{2} ( {\sum }_{k = 1 , 2 , prod} ( 2 \text{?} - 1 ) \vert \frac{c \text{?}}{b \text{?}} \vert ) ⌉$$

$$where$$

$${c}_{1} = {b}_{1} {a}_{2} , {c}_{2} = {b}_{2} {a}_{1} , {c}_{prod} = {b}_{1} {b}_{2}$$

$$\text{?} \text{indicates text missing or illegible when filed}$$

and b_{lead} is the target scale.

According to one example implementation of the first multiplication example, the first set of weights and the second set of weights and the third set of weights may be defined using an iterative method. In step aa2) a current value of the first, second and third sets of weights may be provided. The first, second and third sets of weights may be randomly set to, making sure that each of the first, second and third sets of weights is an integer. In step bb2) the sum of the first, second and third sets of weights may be performed. In step cc2) it may be determined whether the sum is smaller than or equal to the maximal index 2ⁿ^{ₒᵤₜ}−1 of the output quantum register. In step dd2) in case the sum is higher than the maximal index, steps aa2) to bb2) may be repeated (e.g., trying other values for the first, second and third sets of weights). In step ee2) the last determined first, second and third sets of weights may be provided.

In one example, after providing the first set, second set and third set of weights in step ee2), the number of qubits of the output quantum register may be lowered to a power of a closest number of the sum that is a power of two. For example, the last provided weights may fulfill the inequality:

$${\sum }_{{j}_{1} = 0}^{{n}_{1} - 1} \vert {w}_{1 , {j}_{1}} \vert + {\sum }_{{j}_{2} = 0}^{{n}_{2} - 1} \vert {w}_{2 , {j}_{2}} \vert + {\sum }_{{j}_{1} = 0}^{{n}_{1} - 1} {\sum }_{{j}_{2} = 0}^{{n}_{2} - 1} \vert {w}_{prod , {j}_{1} + {j}_{2}} \vert \leq {2}^{{n}_{out}} - 1 .$$

This means that there may be a gap of values between the sum

$${\sum }_{{j}_{1} = 0}^{{n}_{1} - 1} \vert {w}_{1 , {j}_{1}} \vert + {\sum }_{{j}_{2} = 0}^{{n}_{2} - 1} \vert {w}_{2 , {j}_{2}} \vert + {\sum }_{{j}_{1} = 0}^{{n}_{1} - 1} {\sum }_{{j}_{2} = 0}^{{n}_{2} - 1} \vert {w}_{prod , {j}_{1} + {j}_{2}} \vert$$

and the maximal index 2ⁿ^{ₒᵤₜ}−1. The smallest value of this gap which is a power of two (2^{s}) may be selected and the number of qubits nₒᵤₜ may be replaced by the power s of the selected number. Alternatively, in case (in step cc2) is determined that the sum is smaller than or equal to the maximal index 2ⁿ^{ₒᵤₜ}−1, the number of qubits of the output quantum register may be repeatedly lowered (e.g., by one), wherein for each lowering: performing steps aa2) to cc2), wherein the repetition is performed as long as the sum is smaller than or equal to the maximal index 2ⁿ^{ₒᵤₜ}−1 of the output quantum register associated with the lowered number.

According to one example implementation of the first multiplication example, the first set of weights and the second set of weights and the third set of weights may be defined as follows: a first rescaling factor c₁ may be defined for the first set of weights. A second rescaling factor c₂ may be defined for the second set of weights and a third rescaling factor c_{prod} may be defined for the third set of weights. The rescaling factors may be defined as function of the offset and scaling factors as follows: c₁=b₁a₂, c₁=b₂a₁ and c_{prod}=b₁b₂. In this case, the first set of weights may be defined as

$${w}_{1 , {j}_{1}} = {2}^{{j}_{1}} {2}^{M} {c}_{1} / {b}_{lead} ,$$

the second set of weights may be defined as

$${w}_{2 , {j}_{2}} = {2}^{{j}_{2}} {2}^{M} {c}_{2} / {b}_{lead}$$

and the third set of weights may be defined as

$${w}_{prod , {j}_{1 +} {j}_{2}} = {2}^{{j}_{1 +} {j}_{2}} {2}^{M} {c}_{prod} / {b}_{lead} ,$$

where b_{lead} is the target scale.

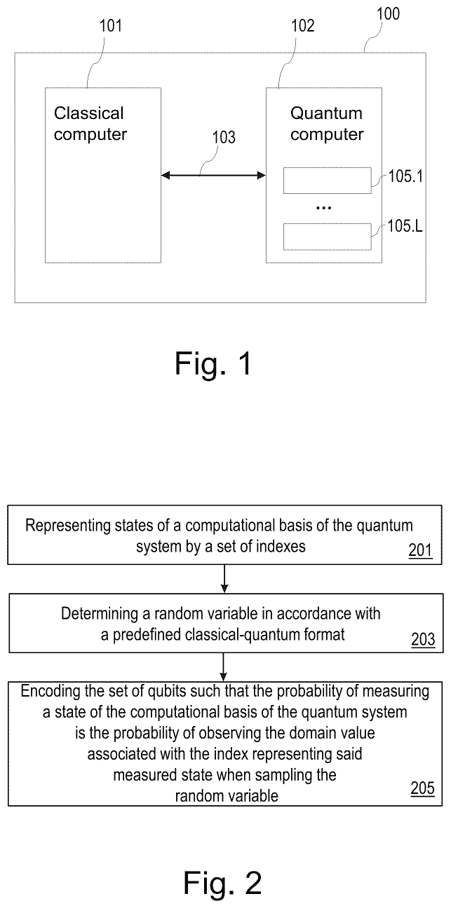

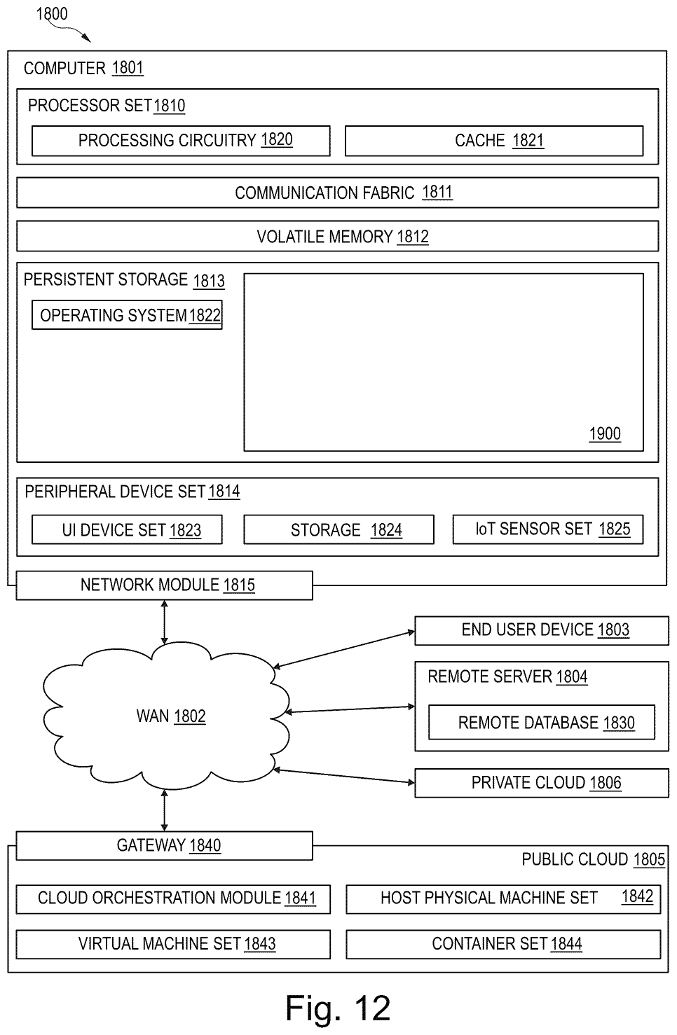

FIG. 1 is a diagram illustrating a computer system in accordance with an example of the present subject matter. The computer system 100 comprises a classical computer 101 and a quantum computer 102. An example implementation of the classical computer 101 is described with reference to FIG. 12. The quantum computer 102 may comprise qubits. For example, qubits may be part of quantum registers 105.1 through 105.L. The classical computer 101 may be configured to control operation of the quantum computer 102. The classical computer 101 may use an interface 103 with the quantum computer 102 to control operation of the quantum computer 102 in accordance with an example of the present subject matter.

FIG. 2 is a flowchart of a method for providing access to a random variable in accordance with an example of the present subject matter. For the purpose of explanation, the method described in FIG. 2 may be implemented in the system illustrated in FIG. 1, but is not limited to this implementation. For example, the method of FIG. 2 may be performed by the computer system 100 using one of the quantum registers 105.1 through 105.L. The set of qubits in the quantum register may define a quantum system.

The states of the computational basis of the quantum system may be represented in step 201 by an ordered set of consecutive nonnegative integer numbers, referred to as a set of indexes

A random variable may be determined in step 203 in accordance with a predefined classical-quantum format. The random variable is valued in a finite domain of classical values such that each value of the domain is derived from a respective index of the set of indexes through an affine relationship. The affine relationship is defined by a scaling factor and an offset factor.

The set of qubits may be encoded in step 205 such that the probability of measuring a state of the quantum system in the computational basis is the probability of observing the domain value associated with the index representing said measured state when sampling the random variable. In other words, in step 205, the set of qubits may be encoded such that the probability of measuring a state of the quantum system in the computational basis is the probability of obtaining the domain value associated with the index representing said measured state, wherein the domain value is obtained by sampling the CEFV variable.

In one alternative implementation of the method of FIG. 2, the alternative method may be performed for a set of ordered pairs instead of the random variable, where a first element of each ordered pair is a complex number, such that the sum of all the squared absolute values of the complex numbers across the set equals one, and a second element of each pair is a real number in a finite domain of classical values, the real number being derived from a respective index of the set of indexes through an affine relationship, the affine relationship being defined by a scaling factor and an offset factor. Indeed, the ordered pairs may be provided as a generalization of the random variable. In each ordered pair, the second element may play the role of the value taken by the random variable, while the squared absolute value of the first element represents the sampling probability associated with value. The alternative method may comprise steps 201. In addition, the alternative method may comprise the steps of determining a set of ordered pairs, where a first element of each ordered pair is a complex number, such that the sum of all the squared absolute values of the complex numbers across the set equals one, and a second element of each pair is a real number in a finite domain of classical values, the real number being derived from a respective index of the set of indexes through an affine relationship, the affine relationship being defined by a scaling factor and an offset factor; and a step of encoding the set of qubits to represent the set of ordered pairs, wherein the encoding is performed such that the quantum state is the complex linear combination of states of the computational basis, where the coefficients of the linear combination are the first elements in the ordered pairs, and the states of the computational basis are represented by the respective indexes, each index being the index in the set of indexes associated to the respective second element of the ordered pair. Using the ordered pairs may be beneficial as it may allow to exploit the invention as a subroutine in quantum algorithms designed to work on complex linear combination of states of the computational basis.

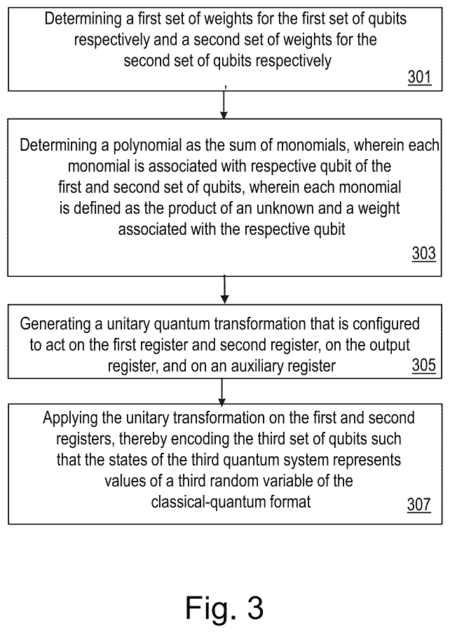

FIG. 3 is a flowchart of a method for adding two random variables in accordance with an example of the present subject matter. For the purpose of explanation, the method described in FIG. 3 may be implemented in the system illustrated in FIG. 1, but is not limited to this implementation. For example, the method of FIG. 3 may be performed by the computer system 100.

For example, the method of FIG. 3 may be performed by the computer system 100 using three quantum registers 105.1 through 105.L. The first and second quantum registers may be used to represent respectively first and second CEFV variables using the method of FIG. 2. For example, the method of FIG. 2 may be executed for each of the first and second quantum registers in order to provide the first and second CEFV variables. The third quantum register may be provided as an output quantum register for the method of FIG. 3.

In step 301, a first set of weights may be determined for the first set of qubits respectively and a second set of weights may be determined for the second set of qubits respectively. The first set of weights and the second set of weights are determined such that the output quantum register after performing the sum represents a third random variable of the classical-quantum format. The first set of weights and the second set of weights are determined so that the output quantum register represents a third CEFV variable. The resulting third CEFV variable may be defined by a CEFV 3-tuple or a CEFV 5-tuple. A polynomial may be defined in step 303. The polynomial may be the sum of monomials, wherein each monomial is associated with respective qubit of the first and second set of qubits, wherein each monomial is defined as the product of an unknown and a weight associated with the respective qubit. In step 305, a unitary quantum transformation may be generated. The unitary quantum transformation is configured to act on the first and second quantum registers, on the output quantum register, and on an auxiliary register may be generated in order to evaluate the polynomial into the output quantum register. The unitary transformation may be applied in step 307 on the first and second quantum registers, thereby encoding in the third set of qubits such that the states of the computational basis of the third quantum system represent values of a third random variable of the classical-quantum format.

In one example, the scaling factor, offset factor and possibly the tolerances may be defined for the third CEFV.

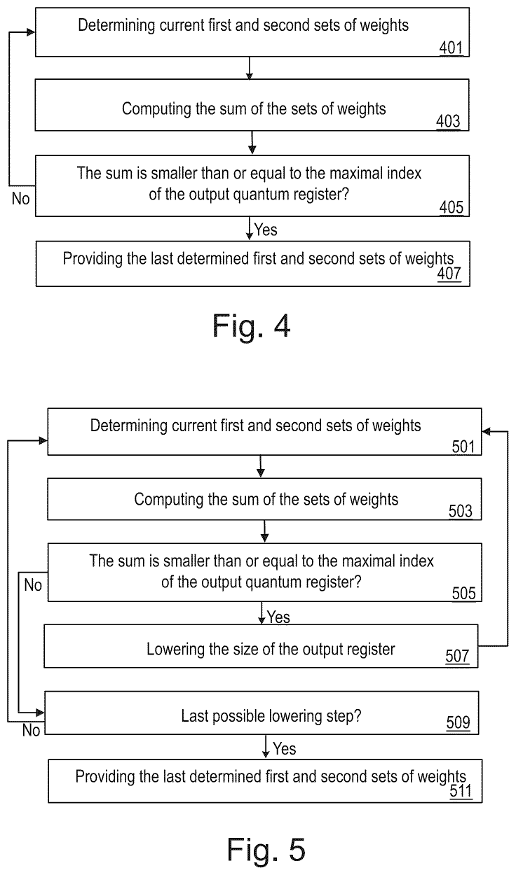

FIG. 4 is a flowchart of a method for determining the set of weights for the addition of two random variables in accordance with an example of the present subject matter. For the purpose of explanation, the method described in FIG. 4 may be implemented in the system illustrated in FIG. 1, but is not limited to this implementation. For example, the method of FIG. 4 may be performed by the computer system 100.

In step 401) a current value of the first and second sets of weights may be provided. The first and second sets of weights may be randomly set, making sure that each of the first and second sets of weights is an integer. In step 403) the sum of the absolute value of the weights in the first and second sets of weights may be performed. In step 405) it may be determined whether the sum is smaller than or equal to the maximal index 2ⁿ^{ₒᵤₜ}−1 of the output quantum register. In case the sum is higher than the maximal index, steps 401) to 405) may be repeated (e.g., trying other values for the first and second sets of weights). In step 407) the last determined first and second sets of weights may be provided.

FIG. 5 is a flowchart of a method for determining the set of weights for the addition of two random variables in accordance with an example of the present subject matter. For the purpose of explanation, the method described in FIG. 5 may be implemented in the system illustrated in FIG. 1, but is not limited to this implementation. For example, the method of FIG. 5 may be performed by the computer system 100.

In step 501 a current value of the first and second sets of weights may be provided. The first and second sets of weights may be randomly set, making sure that each of the first and second sets of weights is an integer. In step 503, the sum of the absolute value of the weights in the first and second sets of weights may be performed. In step 505, it may be determined whether the sum is smaller than or equal to the maximal index 2ⁿ^{ₒᵤₜ}−1 of the output quantum register. In case the sum is smaller than or equal to the maximal index, the size of the output quantum register may be lowered in step 507 and the method goes back to step 501. For example, the number of qubits of the output quantum register may be reduced in step 507 by a value such as one. In case the sum is higher than the maximal index, it may be determined in step 509 whether the number of times the condition of step 505 was not fulfilled is higher than a predefined threshold. If so, the last determined first and second sets of weights may be provided in step 511; otherwise, the method goes back to step 501 (e.g., trying other values for the weights).

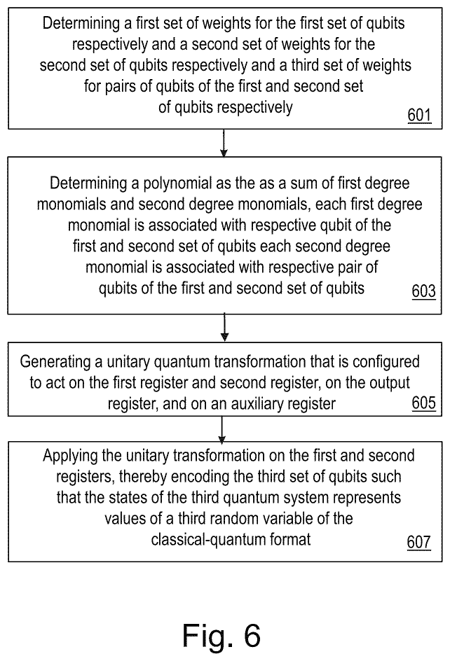

FIG. 6 is a flowchart of a method for multiplication of two random variables in accordance with an example of the present subject matter. For the purpose of explanation, the method described in FIG. 6 may be implemented in the system illustrated in FIG. 1, but is not limited to this implementation. For example, the method of FIG. 6 may be performed by the computer system 100.

For example, the method of FIG. 6 may be performed by the computer system 100 using three quantum registers 105.1 through 105.L. The first and second quantum registers may be used to represent respectively first and second CEFV variables using the method of FIG. 2. For example, the method of FIG. 2 may be executed for each of the first and second quantum registers in order to provide the first and second CEFV variables. The third quantum register may be provided as an output quantum register for the method of FIG. 6.

In step 601, a determination of a first set of weights for the first set of qubits respectively, a second set of weights for the second set of qubits respectively and a third set of weights for the pairs of qubits of the first set and second set of qubits respectively may be performed. The determining of the three sets of weights may be performed such that the output quantum register after performing the multiplication represents a third random variable of the classical-quantum format. A polynomial may be defined in step 603. The polynomial may be defined as a sum of first degree monomials and second degree monomials. Each first degree monomial is associated with respective qubit of the first and second set of qubits. Each first degree monomial is defined as the product of an unknown and a weight associated with the respective qubit. Each second degree monomial is associated with respective pair of qubits of the first and second set of qubits, wherein each second degree monomial is defined as the product of a weight associated with the respective pair of qubits and two unknowns, respectively associated with the qubit in the first set of qubits and the qubit in the second set of qubits. In step 605, a unitary quantum transformation that is configured to act on the first quantum register and second quantum register, on the output quantum register, and on an auxiliary register may be generated in order to evaluate the polynomial into the output quantum register. The unitary transformation may be applied in step 607 on the first and second quantum registers, thereby encoding the third set of qubits such that the states of the computational basis of the third quantum system represent values of a third random variable of the classical-quantum format.

In one example, the scaling factor, offset factor and possibly the tolerances may be defined for the third CEFV.

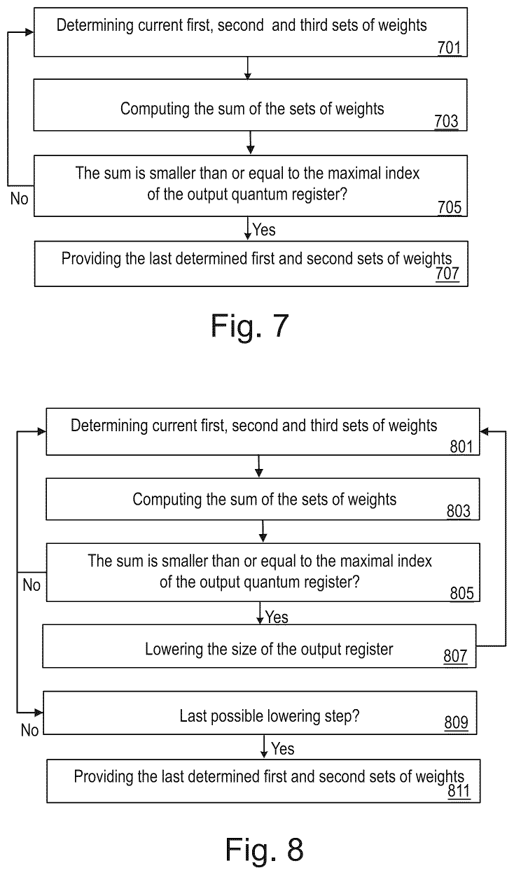

FIG. 7 is a flowchart of a method for determining the weights for the multiplication of two random variables in accordance with an example of the present subject matter. For the purpose of explanation, the method described in FIG. 7 may be implemented in the system illustrated in FIG. 1, but is not limited to this implementation. For example, the method of FIG. 7 may be performed by the computer system 100.

In step 701) a current value of the first, second and third sets of weights may be provided. The first, second and third sets of weights may be randomly set, making sure that each of the first and second sets of weights is an integer. In step 703) the sum of the absolute value of the weights in the first and second and third sets of weights may be performed. In step 705) it may be determined whether the sum is smaller than or equal to the maximal index 2ⁿ^{ₒᵤₜ}−1 of the output quantum register. In case the sum is higher than the maximal index, steps 701) to 705) may be repeated (e.g., trying other values for the first and second sets of weights). In step 707) the last determined first, second and third sets of weights may be provided.

FIG. 8 is a flowchart of a method for determining the weights for the multiplication of two random variables in accordance with an example of the present subject matter. For the purpose of explanation, the method described in FIG. 8 may be implemented in the system illustrated in FIG. 1, but is not limited to this implementation. For example, the method of FIG. 8 may be performed by the computer system 100.

In step 801 a current value of the first, second and third sets of weights may be provided. The first, second and third set of weights may be randomly set, making sure that each of the first and second sets of weights is an integer. In step 803, the sum of the absolute value of the weights in the first and second and third sets of weights may be performed. In step 805, it may be determined whether the sum is smaller than or equal to the maximal index 2ⁿ^{ₒᵤₜ}−1 of the output quantum register. In case the sum is smaller than or equal to the maximal index, the size of the output quantum register may be lowered in step 807 and the method goes back to step 801. For example, the number of qubits of the output quantum register may be reduced in step 507 by a value such as one. In case the sum is higher than the maximal index, it may be determined in step 809 whether the number of times the condition of step 805 was not fulfilled is higher than a predefined threshold. If so, the last determined first, second and third sets of weights may be provided in step 811; otherwise, the method goes back to step 801 (e.g., trying other values for the weights).

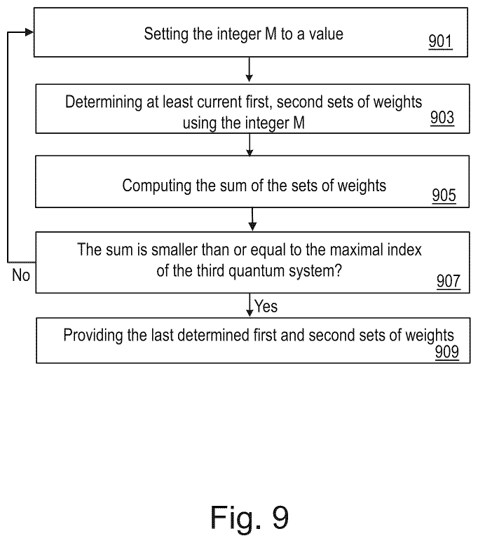

FIG. 9 is a flowchart of a method for determining weights for the addition of two random variables in accordance with an example of the present subject matter. For the purpose of explanation, the method described in FIG. 9 may be implemented in the system illustrated in FIG. 1, but is not limited to this implementation. For example, the method of FIG. 9 may be performed by the computer system 100.

In this example, the determined weights for the qubits of the registers may include the integer number M as described above. In this case, the iterative method to find the weights may be executed as follows.

In step 901) a current value of the first and second sets of weights may be determined using the integer M. The first and second sets of weights may be randomly set in step 903, making sure that each of the first and second sets of weights is an integer. In step 905) the sum of the absolute value of the weights in the first and second sets of weights may be performed. In step 907) it may be determined whether the sum is smaller than or equal to the maximal index 2ⁿ^{ₒᵤₜ}−1 of the output quantum register. In case the sum is higher than the maximal index, steps 901) to 907) may be repeated (e.g., by decreasing the integer M by one). In step 909) the last determined first and second sets of weights may be provided.

In the following, an example mathematical modelling may be described. The mathematical modelling may describe the creation of the CEFV variable, the addition of two CEFV variables and the product of two CEFV variables.

The CEFV variable may be defined as follows. The CEFV variable is of length n. The CEFV variable is a tuple

$$ℱ = ( \vert . > , , {g}_{a , b} , {ϵ}^{-} , {ϵ}^{+} )$$

where a∈ [symbol] is the offset, b∈ [symbol] \{0} is the scaling factor, ϵ⁻, ϵ⁺∈[0, +∞) are the below and above errors respectively. The domain is the uniformly spaced grid

$$= \{ a + bz \vert z ∈ \{ 0 , I , {2}^{n -} - 1 \} \} ,$$

while the encoding is

$${g}_{a , b}^{fp} ( x ) := \frac{x - a}{b} .$$

Allowing a negative scaling factor, b<0, may appear redundant. Nevertheless, it is encompassed as it may enable sign swap by simply adjusting the classical parameters, without any quantum state manipulation. In addition, two CEFV variables may insist on the same register |.>. This may be useful in algorithms to economize on the number of qubits. For instance, for adding a fixed number c∈ [symbol] to a floating-point variable, it may be enough to create a new variable with a modified aₒᵤₜ=aᵢₙ+c, without need to instantiate a new register. It may also be useful to interpret the same register both as an integer and as a floating point, by giving rise to two variables. More broadly, the quantum registers of two variables may share some of the qubits. A quantum algorithm, seen as a tool operating on quantum variables, may make calculations both by (re)defining CEFV variables, and by manipulating input states through quantum circuits.

In one example, the CEFV variables may be equipped with errors ϵ− and ϵ+ in order to keep track of the error propagation, as the computation of the sum and the product may be performed only up to a rounding error. This leads to the definition of compatibility between random variables and states as follows. Let Y be a random variable valued in any domain [symbol] _{Y}, and let

$$ℱ = ( \vert . > , , {g}_{a , b}^{fp} , {ϵ}^{-} , {ϵ}^{+} )$$

be a CEFV variable of length n, and |ψ> an n-qubit state. Let X be the random variable g_{a,b}^{fp}-encoded by |ψ>. The random variable Y is said [symbol] -compatible with the state |ψ> if −ϵ⁻≤Y−X≤ϵ⁺. For example, Y [symbol] |ψ> means that |ψ> represents an approximation of Y under the encoding and the tolerances specified by [symbol] .

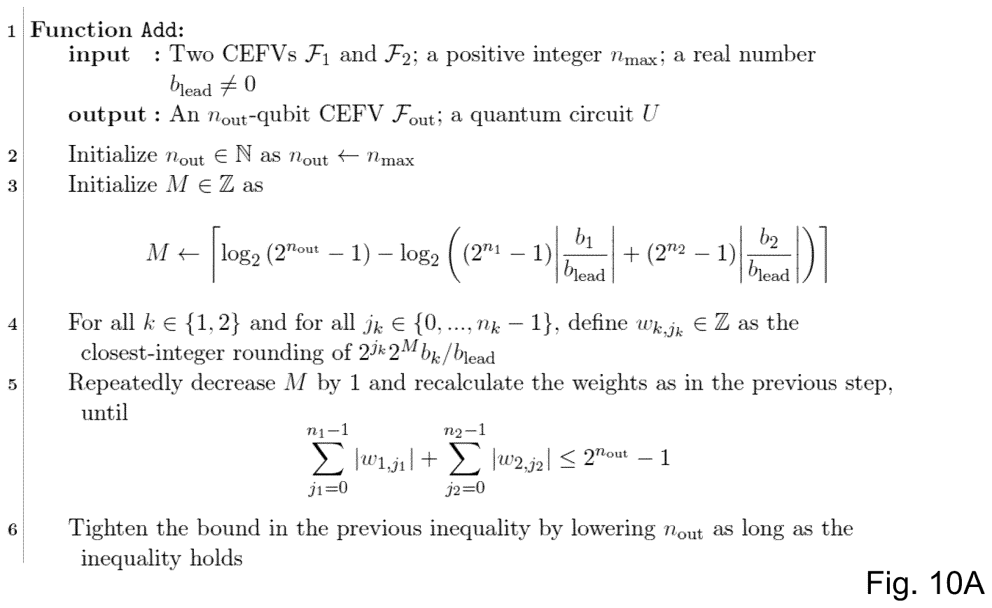

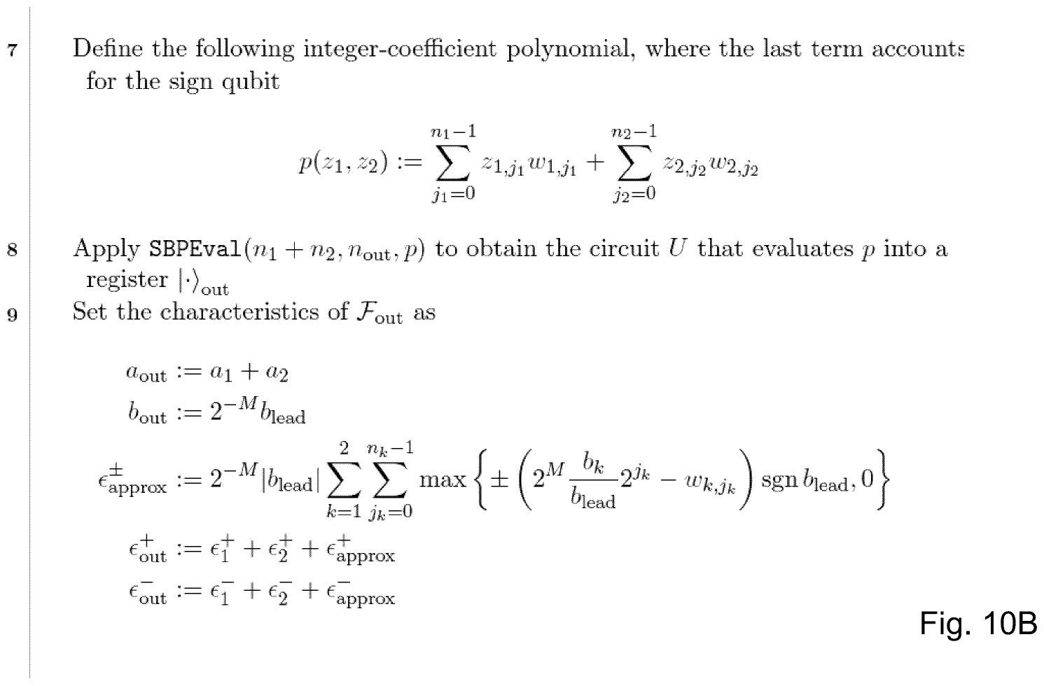

FIGS. 10A and 10B are pseudocode of a function for adding two random variables in accordance with an example of the present subject matter. The pseudocode represents an algorithm named “Algorithm 1”. As shown in FIGS. 10A and 10B, the algorithm is defined in a sequence of steps for performing the sum of two CEFV variables. The steps comprise a step 2 of initializing the number of qubits in the output quantum register, a step 3 of initializing the integer M in accordance with the definition shown in FIG. 10A, a step 4 of determining the weights using the integer M, a step 5 of checking the inequality shown in FIG. 10A, a step 6 to lower the number of qubits in the output quantum register, a step 7 of defining the polynomial, a step 8 of applying the unitary transformation by the function SBPEval(.) and a step 9 for providing the characteristics of the resulting CEFV variable e.g., the offset and scaling factors and the tolerance range. The mathematical modelling of this sum may be provided as follows.

Let [symbol] and [symbol] be two CEPVs of size n₁ and n₂ resp.,
${where {ℱ}_{j} = ( \vert \cdot 〉}_{j} , 𝒟 \text{?} = {𝒟}_{j} , g \text{?} = {g}_{j} , {ϵ}_{j}^{-} , {ϵ}_{j}^{+} )$
for j = 1, 2. Moreover, let nₘₐₓ be a positive integer, and
b_{lead} a non-null real number. Then Algorithm 1 outputs an nₒᵤₜ-gubit CEFV [symbol] ₒᵤₜ = (|· [symbol] ₒᵤₜ,
$𝒟 \text{?} = {𝒟}_{out} , g \text{?} = {g}_{out} , {ϵ}_{out}^{-} , {ϵ}_{out}^{+} ) and a quantum circuit U with the$
following characteristics:
(i) nₒᵤₜ ≤ nₘₐₓ
(ii) the width of U is at most n₁ + n₂ + nₒᵤₜ + 1
(iii) in the basis mode of 1- and 2-qubit gates, the gate count of U is
$( {n}_{out}^{2} + {n}_{out} ( {n}_{1} + {n}_{2} ) )$
(iv) for j = 1, 2, given any yⱼ ∈ [symbol] and xⱼ ∈ [symbol] ⱼ such that -ϵⱼ⁻, ≤ yⱼ − xⱼ ≤ ϵⱼ⁺, U behaves
as follows:
$U \vert {g}_{1} ( {x}_{1} ) 〉 \vert {g}_{2} ( {x}_{2} ) 〉 \vert 0 〉 \vert 0 〉 = \vert {g}_{1} ( {x}_{1} ) 〉 \vert {g}_{2} ( {x}_{2} ) 〉 \vert {z}_{out} 〉 \vert 0 〉$
where zₒᵤₜ satisfies
$- {ϵ}_{out}^{-} \leq {y}_{1} + {y}_{2} - {g}_{out}^{- 1} ( {z}_{out} ) \leq {ϵ}_{out}^{+} .$
In other words, xₒᵤₜ: = gₒᵤₜ⁻¹(zₒᵤₜ) approximates the sum of y₁ and y₂, within the
tolerances of [symbol] ₒᵤₜ.
$\text{?} \text{indicates text missing or illegible when filed}$

The statement of items (i), (ii) and (iii) may be easily proved mathematically using, for example, the results of the underlying SBPEval routine, as described for instance in R. Seidel, N. Tcholtchev, S. Bock, C. K.-U. Becker, and M. Hanswirth, “Efficient Floating Point Arithmetic for Quantum Computers,” IEEE Access, vol. 10, pp. 72400-72415, 2022. Conversely (iv) can be proved as it follows:

$${y}_{out} - {x}_{out} = ( {y}_{1} - {x}_{1} ) + ( {y}_{2} - {x}_{2} ) + ( {x}_{1} - {x}_{2} - {x}_{out} ) \leq {ϵ}_{1}^{+} + {ϵ}_{2}^{+} + ( {x}_{1} + {x}_{2} - {x}_{out} ) ,$$

The choice of nₒᵤₜ, guarantees no overflow in the polynomial evaluation, so that

$${z}_{out} = {\sum }_{{j}_{1} = 0}^{{n}_{1} - 1} {w}_{1 , {j}_{1}} {z}_{1 , {j}_{1}} + {\sum }_{{j}_{2} = 0}^{{n}_{2} - 1} {w}_{2 , {j}_{2}} {z}_{2 , {j}_{2}} .$$

### Then

$$\begin{matrix}( {x}_{1} + {x}_{2} - {x}_{out} ) = ( {a}_{1} + {b}_{1} {z}_{1} ) + ( {a}_{2} + {b}_{2} {z}_{2} ) − ( {a}_{1} + {a}_{2} + {b}_{out} {z}_{out} ) \\ = ( {b}_{1} {z}_{1} + {b}_{2} {z}_{2} ⋯ {2}^{− M} {b}_{lead} {z}_{out} ) \\ = {\sum }_{k = 1}^{2} ( {b}_{k} {z}_{k} - {2}^{− M} {b}_{lead} {\sum }_{jk = 0}^{{n}_{k} - 1} {w}_{k , jk} {z}_{k , jk} ) \\ = {2}^{- M} {b}_{lead} {\sum }_{k = 1}^{2} ( {2}^{M} \frac{{b}_{k}}{{b}_{lead}} {z}_{k} {\sum }_{jk = 0}^{{n}_{k} - 1} {w}_{k , jk} {z}_{k , jk} ) \\ = {2}^{- M} {b}_{lead} {\sum }_{k = 1}^{2} {\sum }_{jk = 0}^{{n}_{k} - 1} ( {2}^{M} \frac{{b}_{k}}{{b}_{lead}} {2}^{jk} - {w}_{k , jk} ) {z}_{k , jk} \\ \leq \begin{matrix}{2}^{- M} \vert {b}_{lead} \vert {\sum }_{k = 1}^{2} {\sum }_{jk = 0}^{{n}_{k} - 1} max \{ ( {2}^{M} \frac{{b}_{k}}{{b}_{lead}} {2}^{jk} - \\ {w}_{k , jk} ) sgn {b}_{lead} , 0 \} .\end{matrix}\end{matrix}$$

The proof for ϵₒᵤₜ ⁻ is similar.

[symbol]

The statements of items (i), (ii), (iii) and (iv) may hold for any [w_{k,j}_{ₖ}]_{k,j}_{ₖ} however defined, as long as the no-overflow condition is guaranteed, namely the sum of the absolute value of the weights in the first set of weights and in the second set of weights is smaller than or equal to the maximal index 2ⁿ^{ₒᵤₜ}−1 of the output quantum register. The choice in step 4 of FIG. 10A may be optimal in the sense that (a) the integer M is calculated in such a way to fully exploit the precision achievable in nₘₐₓ qubits, (b) the definition of the weights minimizes and balances ϵₐₚₚᵣₒₓ⁺ and ϵₐₚₚᵣₒₓ⁻. Regarding (a), the initialization in step 3 of FIG. 10A guarantees that

$${\sum }_{{j}_{1} = 0}^{{n}_{1} - 1} \vert {w}_{1 = 1 , {j}_{1}} \vert + {\sum }_{{j}_{2} = 0}^{{n}_{2} - 1} \vert {w}_{2 , {j}_{2}} \vert \leq {2}^{{n}_{out}} - 1 .$$

And at the same time guarantees that step 5 of FIG. 10A requires few iterations

Hence, in order to sum two CEFVs, the offsets may be simply summed together, while states may be processed by a quantum circuit that keeps into account the scaling factors. More precisely, before applying a quantum addition algorithm, both registers may be aligned to the same scaling factor, b_{lead} as described with the algorithm of FIGS. 10A and 10B. The rescaling factor for [symbol] ₂ may be b_{lead}/b₂, and may be rounded to a binary fraction in order to fit into the representation possibilities of the target register. Said binary fraction is classically known, so that the sum of the two states in their respective scales, gets translated into a weighted sum between integers. The algorithm of FIGS. 10A and 10B formalizes this approach in which an arbitrary b_{lead} is taken in input, and is further processed to output a bₒᵤₜ such that bₒᵤₜ/b_{lead} is a power of 2, with integer exponent, and bₒᵤₜ is optimized to exploit the available output binary digits for as many significant digits as possible.

In one example implementation of the algorithm of FIGS. 10A and 10B, the target scale b_{lead} may be used as follow. Indeed, the choice of the target scale b_{lead} may both affect the approximation degree and the circuit complexity of the sum. For example, the target scale may be equal to the first scaling factor b₁ or equal to the second scaling factor b₂. In this way, the weights of the corresponding register become powers of 2, and the circuit may simplify significantly. The two choices b_{lead}=b₁ and b_{lead}=b₂ may be equally performant. The choice of b_{lead} may not only impact the performance of individual sum where it is introduced, but also defines the output variable, thus conditioning the cost of all subsequent interactions of the output itself.

In one example, the algorithm described in FIGS. 10A and 10B may be improved as follow. (a) If all weights in both w₁ and w₂ share a common factor of 2, they can be divided by such factor that can be accounted classically, thus reducing the complexity of the circuit. (b) If once applying (a), the terms in the CEFV variable [symbol] ₂ are all multiple of 2^{l}, for some positive integer l, and at the same time w_{1,j}_{₁}=2^{j}^{₁} for all j₁=0, . . . , l−1, then the l least significant qubits of the sum may not be impacted by [symbol] ₂, and may be copied directly from the corresponding digits in [symbol] ₁ via CNOT gates. The condition on the weights w_{1,j}_{₁} may be likely verified in practice, because it is implied by the choice of b_{lead}=b₁. (c) The previous improvement (b) may be rewritten in a more general form as follows: if only one input qubit of one input variable affects the least significant output variable, then it can be copied to the output variable via a CNOT gate, and then improvement (a) may be invoked again, recursively. (d) The rounding in step 4 of FIG. 10A may be modified to map a 0.5 decimal into 0 instead 1. This may not affect the error, but reduce weights. (e) An iteration of step 5 of FIG. 10A is equivalent to rounding all weights to a power of 2. At the last iteration, a more refined technique may be to round only some weights; sufficiently many to satisfy the exit condition in step 5, but as little as possible to limit approximation.

In one example, for any given positive integer L, in the attempt to increase the result precision, it may be possible to calculate L additional binary digits by resorting to L ancilla qubits, and then uncompute these additional qubits by means of a subtraction modulo 2 L, before returning the result.

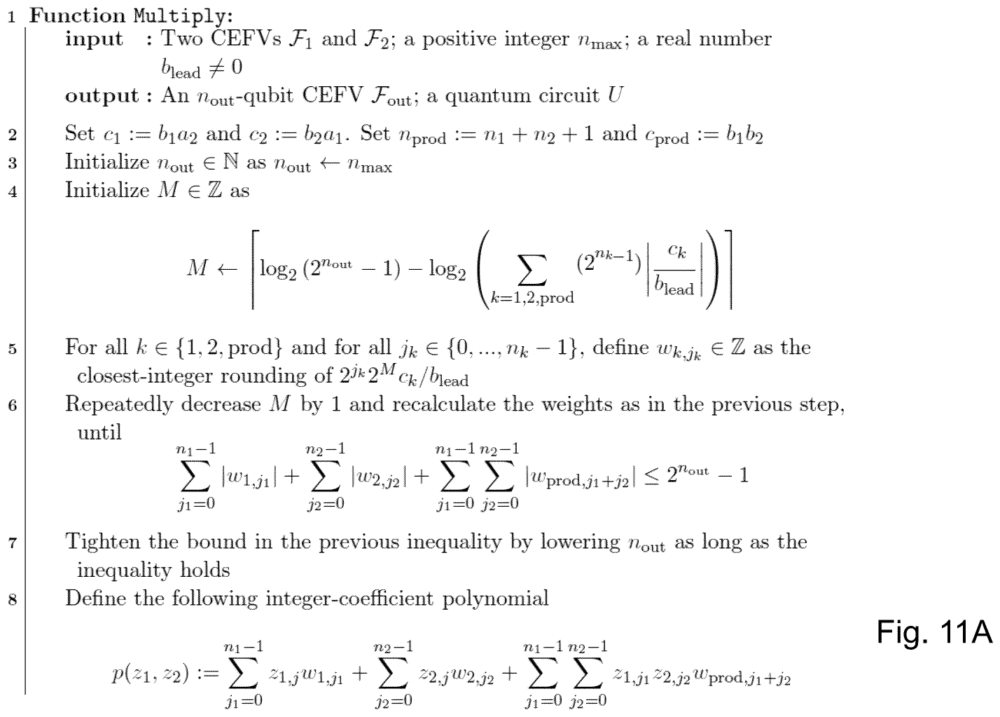

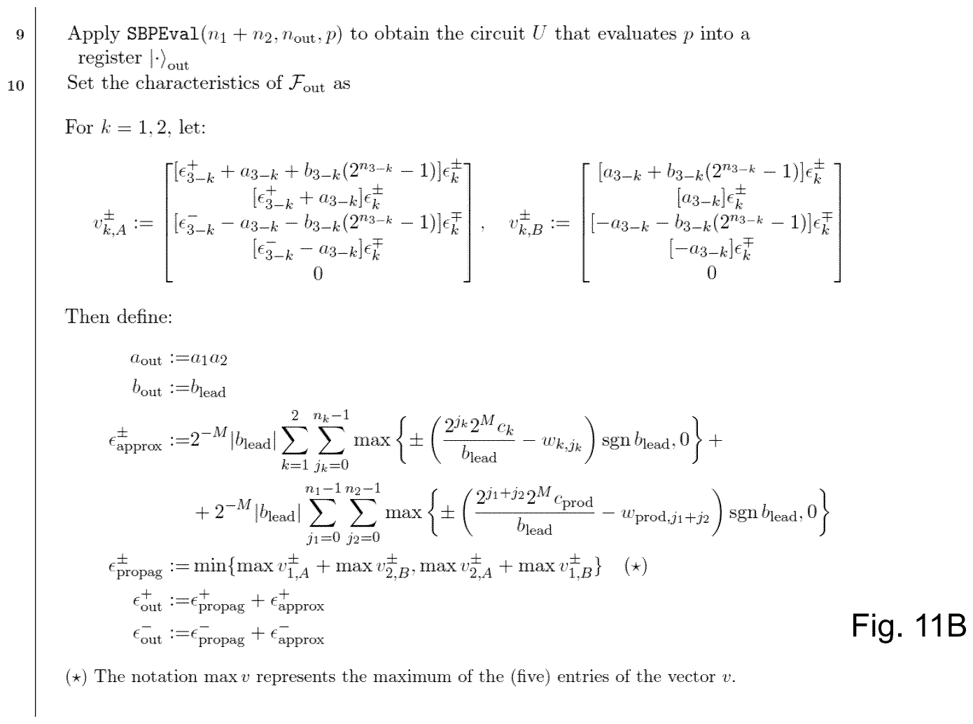

FIGS. 11A and 11B are pseudocode of a function for multiplying two random variables in accordance with an example of the present subject matter. The pseudocode represents an algorithm named “Algorithm 2”. As shown in FIGS. 11A and 11B, the algorithm is defined in a sequence of steps for performing the product of two CEFV variables. The steps comprise a step 2 of initializing rescaling factors c₁, c₂ and c_{prod}, a step 3 of initializing the number of qubits in the output quantum register, a step 4 of initializing the integer M in accordance with the definition shown in FIG. 11A, a step 5 of determining the weights using the integer M and the rescaling factors, a step 6 of checking the inequality shown in FIG. 11A, a step 7 to lower the number of qubits in the output quantum register, a step 8 of defining the polynomial, a step 9 of applying the unitary transformation by the function SBPEval(.) and a step 10 for providing the characteristics of the resulting CEFV variable e.g., the offset and scaling factors and the tolerance range. The mathematical modelling of this multiplication may be provided as follows.

Let [symbol] and [symbol] be two CEFVs of size n₁ and n₂ resp.,
${where {ℱ}_{j} = ( \vert \cdot 〉}_{j} , 𝒟 \text{?} = {𝒟}_{j} , g \text{?} = {g}_{j} , {ϵ}_{j}^{-} , {ϵ}_{j}^{+} )$
for j = 1, 2. Moreover, let nₘₐₓ ≥ n₁, n₂. Then Algorithm 2 outputs an nₒᵤₜ-qubit CEFV
${{ℱ}_{out} = ( \vert \cdot 〉}_{out} , {𝒟}_{{a}_{out} , {b}_{out}}^{fp} = {𝒟}_{out} , {g}_{{a}_{out} , {b}_{out}}^{fp} = {g}_{out} , {ϵ}_{out}^{-} , {ϵ}_{out}^{+} )$
and a quantum circuit U with the following characteristics:
(i) nₒᵤₜ ≤ nₘₐₓ
(ii) the width of U is at most n₁ + n₂ + nₒᵤₜ + 1
(ii) in the basis made of 1- and 2-qubit gates, the gate count of U is [symbol] (nₒᵤₜn₁n₂)
(iv) for j = 1, 2, given any yⱼ ∈ [symbol] and xⱼ ∈ [symbol] ⱼ such that -ϵⱼ⁻ ≤ yⱼ − xⱼ ≤ ϵⱼ⁺, U behaves
as follows:
$U \vert {g}_{1} ( {x}_{1} ) 〉 \vert {g}_{2} ( {x}_{2} ) 〉 \vert 0 〉 \vert 0 〉 = \vert {g}_{1} ( {x}_{1} ) 〉 \vert {g}_{2} ( {x}_{2} ) 〉 \vert {z}_{out} 〉 \vert 0 〉$
where zₒᵤₜ satisfies
$- {ϵ}_{out}^{-} \leq {y}_{1} {y}_{2} - {g}_{out}^{- 1} ( {z}_{out} ) \leq {ϵ}_{out}^{+} .$
In other words, xₒᵤₜ : = gₒᵤₜ⁻¹(zₒᵤₜ) approximates the product of y₁ and y₂, within the
tolerances of [symbol] ₒᵤₜ.
$\text{?} \text{indicates text missing or illegible when filed}$

Hence, given two inputs X₁=a₁+b₁Z₁ and X₂=a₂+b₂Z₂, their product is X₁X₂=a₁a₂+a₁b₂Z₂+a₂b₁Z₁+b₁b₂Z₁Z₂, so that there is a way to compute the integer product Z₁Z₂. Algorithm 2 shows an implementation recurring to a single polynomial, which is more accurate than making the product Z₁Z₂ at first, and the sum afterwards.

The present subject matter comprises the following clauses.

Clause 1. A method for providing a quantum variable, comprising: providing a quantum register comprising a set of qubits defining a quantum system; representing states of the quantum system in a computational basis by an ordered set of consecutive nonnegative integer numbers, referred to as a set of indexes; determining a random variable in accordance with a predefined classical-quantum format, wherein the random variable is valued in a finite domain of classical values such that each value of the domain is derived from a respective index of the set of indexes through an affine relationship, the affine relationship being defined by a scaling factor and an offset factor; encoding the set of qubits to represent the random variable, wherein the encoding is performed such that the probability of measuring a state of the quantum system in the computational basis is the probability of observing the domain value associated with the index representing said measured state when sampling the random variable.

Clause 2. The method of clause 1, wherein determining the random variable in accordance with the classical-quantum format further comprises: determining a tolerance range; performing the encoding such that an approximate of the domain value and the domain value are represented with the same quantum state in case the difference between the domain value and the approximate is within the tolerance range.

Clause 3. A method for providing quantum variables, comprising: providing a first quantum register comprising a first set of qubits defining a first quantum system and a second quantum register comprising a second set of qubits defining a second quantum system; representing states of the first quantum system in a computational basis by an ordered set of consecutive first indexes; representing states of the second quantum system in a computational basis by an ordered set of consecutive second indexes; determining a first random variable and a second random variable of a classical-quantum format, the first random variable being valued in a finite first domain of classical values such that each value of the first domain is derived from a respective first index of the set of first indexes through a first affine relationship, the first affine relationship being defined by a first scaling factor and a first offset factor, the second random variable being valued in a finite second domain of classical values such that each value of the second domain is derived from a respective second index of the set of second indexes through a second affine relationship, the second affine relationship being defined by a second scaling factor and a second offset factor; encoding the first set of qubits and the second set of qubits for representing the first and second random variables.

Clause 4. The method of clause 3, the first and second random variables being independent, wherein the encoding comprises: encoding the first set of qubits such that the probability of measuring a state of the first quantum system in the computational basis is the probability of observing the first domain value associated with the first index representing said measured state when sampling the first random variable; and encoding the second set of qubits such that the probability of measuring a state of the second quantum system in the computational basis is the probability of observing the second domain value associated with the second index representing said measured state when sampling the second random variable.

Clause 5. The method of clause 3, the first and second random variables being dependent, wherein the encoding of the first and second sets of qubits is performed such that the probability of measuring a state of a joint quantum system of the first and second quantum systems in the computational basis is the probability of jointly observing the first domain value associated with the first index representing said measured state when sampling the first random variable and the second domain value associated with the second index representing said measured state when sampling the second random variable.

Clause 6. The method of any of the preceding clauses 3 to 5, further comprising determining a sum of the first and second random variables, the performing of the sum comprising: providing an output quantum register comprising a third set of qubits, thereby defining a third quantum system, the first, second and third quantum systems forming a joint quantum system; determining a first set of weights for the first set of qubits respectively and a second set of weights for the second set of qubits respectively, the determining is performed such that the output quantum register after performing the sum represents a third random variable of the classical-quantum format; defining an unknown for each qubit of the first and second quantum registers; defining a monomial for each unknown, the monomial being the unknown multiplied by the weight associated to the respective qubit; defining a polynomial as the sum of the monomials; generating a unitary quantum transformation that is configured to act on the first quantum register and second quantum register, on the output quantum register, and on an auxiliary register, in order to evaluate the polynomial into the output quantum register; applying the unitary transformation on the first quantum register and second quantum register, thereby encoding the third set of qubits such that the states of the computational basis of the third quantum system represent values of a third random variable of the classical-quantum format.

Clause 7. The method of clause 6, wherein the states of the computational basis of the third quantum system represent values of the third random variable of the classical-quantum format through a third affine relationship defined by a third scaling factor and a third offset factor, wherein the third offset factor is the classical sum of the first and second offsets and the third scaling factor is the product of an alignment scale and a predefined target scale, wherein the alignment scale is the inverse of a power of two such that the sum can be performed without overflow, the alignment scale being provided

Clause 8. The method of clause 7, wherein the alignment scale is equal to the inverse of two to the power of an integer M, where M is the highest integer so that the sum of the absolute value of the weights in the first set of weights and in the second set of weights is smaller than or equal to the maximal index of the output quantum register.

Clause 9. The method of clause 7 or 8, the target scale being one of the first and second scaling factors.

Clause 10. The method of clause 9 or 8, wherein the determining of the first and second set of weights is iteratively performed by at least: a) initializing M to an upper bound b) determining current first and second sets of weights; c) computing the sum of the absolute value of the weights in the first and in the second sets of weights; d) determining whether the sum is smaller than or equal to the maximal index 2ⁿ^{ₒᵤₜ}−1 of the output quantum register; e) in case the sum is higher than the maximal index, decreasing M by 1 and repeating b) to d); providing the last determined first and second sets of weights.

Clause 11. The method of clause 10, the providing of the first set and second set of weights further comprising lowering the number of qubits in the output quantum register to a closest number of the sum that is a power of two.

Clause 12. The method of any of the preceding clauses 6 to 11, the sum being determined in place, wherein the output quantum register is one of the first and second quantum registers.

Clause 13. The method of any of the preceding clauses 3 to 12, further comprising performing a multiplication of the first and second random variables, the performing of the multiplication comprising: providing an output quantum register comprising a third set of qubits, thereby defining a third quantum system, the first, second and third quantum systems forming a joint quantum system; determining a first set of weights for the first set of qubits respectively and a second set of weights for the second set of qubits respectively and a third set of qubits for the pairs of qubits of the first set and second set of qubits respectively, the determining being performed such that the output quantum register after performing the multiplication represents a third random variable of the classical-quantum format; defining the polynomial as a sum of first degree monomials and second degree monomials, wherein each first degree monomial is associated with respective qubit of the first and second set of qubits, wherein each first degree monomial is defined as the product of an unknown and a weight associated with the respective qubit, wherein each second degree monomial is associated with respective pair of qubits of the first and second set of qubits, wherein each second degree monomial is defined as the product of an unknown and a weight associated with the respective pair of qubits; generating a unitary quantum transformation that is configured to act on the first quantum register and second quantum register, on the output quantum register, and on an auxiliary register, in order to evaluate the polynomials into the output quantum register; applying the unitary transformation on the first and second quantum registers, thereby encoding the third set of qubits such that the states of the computational basis of the third quantum system represent values of a third random variable of the classical-quantum format.

Clause 14. The method of clause 13, wherein the states of the computational basis of the third quantum system represent values of the third random variable of the classical-quantum format through a third affine relationship defined by a third scaling factor and a third offset factor, wherein the third offset factor is the classical product of the first and second offsets and the third scaling factor is a given target scale.

Clause 15. The method of any of the preceding clauses 13 to 14, each weight comprising an alignment scale, wherein the alignment scale is equal to the inverse of two to the power of an integer M, where M is the highest integer so that the sum of the absolute value of the weights in the first set of weights and in the second set of weights and in the third set of weights is smaller than or equal to the maximal index of the output quantum register, wherein the alignment scale is provided such that the product can be performed without overflow.

Clause 16. The method of clause 14 or 15, the target scale being one of the first and second scaling factors.

Clause 17. The method of any of the preceding clauses 13 to 16, wherein the determining the first and second set of weights is iteratively performed by at least: a) determining current first, second and third sets of weights; b) computing the sum of the first, second and third sets of weights; c) determining whether the sum is smaller than or equal to the maximal index 2ⁿ^{ₒᵤₜ}−1 of the output quantum register; d) in case the sum is higher than the maximal index, repeating a) to c); e) providing the last determined first, second and third sets of weights.

Clause 18. The method of clause 17, the providing of the first set, second set and third set of weights further comprising lowering the number of qubits in the output quantum register to a power of two number which is closest to the sum.

Clause 19. The method of any of the preceding clauses 1 to 18, further comprising performing a statistical analysis using the method of any of the preceding claims.

Clause 20. The method of any of the preceding clauses 1 to 19, being automatically performed.

Clause 21. The method of any of the preceding clauses 1 to 20, wherein each scaling factor of the scaling factors is a nonzero real number and/or each offset factor of the offset factors is a real number.

Computing environment 1800 contains an example of an environment for the execution of at least some of the computer code involved in performing the inventive methods, such as a code 1900 for providing access to a quantum random variable e.g., performing the classical part of the computations involved in the definition of the quantum variable. In addition to block 1900, computing environment 1800 includes, for example, computer 1801, wide area network (WAN) 1802, end user device (EUD) 1803, remote server 1804, public cloud 1805, and private cloud 1806. In this embodiment, computer 1801 includes processor set 1810 (including processing circuitry 1820 and cache 1821), communication fabric 1811, volatile memory 1812, persistent storage 1813 (including operating system 1822 and block 1900, as identified above), peripheral device set 1814 (including user interface (UI) device set 1823, storage 1824, and Internet of Things (IoT) sensor set 1825), and network module 1815. Remote server 1804 includes remote database 1830. Public cloud 1805 includes gateway 1840, cloud orchestration module 1841, host physical machine set 1842, virtual machine set 1843, and container set 1844.

COMPUTER 1801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1830. As is well understood in the art of computer technology, and depending upon the technology, performance of a computer-implemented method may be distributed among multiple computers and/or between multiple locations. On the other hand, in this presentation of computing environment 1800, detailed discussion is focused on a single computer, specifically computer 1801, to keep the presentation as simple as possible. Computer 1801 may be located in a cloud, even though it is not shown in a cloud in FIG. 12. On the other hand, computer 1801 is not required to be in a cloud except to any extent as may be affirmatively indicated.

PROCESSOR SET 1810 includes one, or more, computer processors of any type now known or to be developed in the future. Processing circuitry 1820 may be distributed over multiple packages, for example, multiple, coordinated integrated circuit chips. Processing circuitry 1820 may implement multiple processor threads and/or multiple processor cores. Cache 1821 is memory that is located in the processor chip package(s) and is typically used for data or code that should be available for rapid access by the threads or cores running on processor set 1810. Cache memories are typically organized into multiple levels depending upon relative proximity to the processing circuitry. Alternatively, some, or all, of the cache for the processor set may be located “off chip.” In some computing environments, processor set 1810 may be designed for working with qubits and performing quantum computing.

Computer readable program instructions are typically loaded onto computer 1801 to cause a series of operational steps to be performed by processor set 1810 of computer 1801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1821 and the other storage media discussed below. The program instructions, and associated data, are accessed by processor set 1810 to control and direct performance of the inventive methods. In computing environment 1800, at least some of the instructions for performing the inventive methods may be stored in block 1900 in persistent storage 1813.

COMMUNICATION FABRIC 1811 is the signal conduction path that allows the various components of computer 1801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1812 is any type of volatile memory now known or to be developed in the future. Examples include dynamic type random access memory (RAM) or static type RAM. Typically, volatile memory 1812 is characterized by random access, but this is not required unless affirmatively indicated. In computer 1801, the volatile memory 1812 is located in a single package and is internal to computer 1801, but, alternatively or additionally, the volatile memory may be distributed over multiple packages and/or located externally with respect to computer 1801.

PERSISTENT STORAGE 1813 is any form of non-volatile storage for computers that is now known or to be developed in the future. The non-volatility of this storage means that the stored data is maintained regardless of whether power is being supplied to computer 1801 and/or directly to persistent storage 1813. Persistent storage 1813 may be a read only memory (ROM), but typically at least a portion of the persistent storage allows writing of data, deletion of data and re-writing of data. Some familiar forms of persistent storage include magnetic disks and solid state storage devices. Operating system 1822 may take several forms, such as various known proprietary operating systems or open source Portable Operating System Interface-type operating systems that employ a kernel. The code included in block 1900 typically includes at least some of the computer code involved in performing the inventive methods.

PERIPHERAL DEVICE SET 1814 includes the set of peripheral devices of computer 1801. Data communication connections between the peripheral devices and the other components of computer 1801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1823 may include components such as a display screen, speaker, microphone, wearable devices (such as goggles and smart watches), keyboard, mouse, printer, touchpad, game controllers, and haptic devices. Storage 1824 is external storage, such as an external hard drive, or insertable storage, such as an SD card. Storage 1824 may be persistent and/or volatile. In some embodiments, storage 1824 may take the form of a quantum computing storage device for storing data in the form of qubits. In embodiments where computer 1801 is required to have a large amount of storage (for example, where computer 1801 locally stores and manages a large database) then this storage may be provided by peripheral storage devices designed for storing very large amounts of data, such as a storage area network (SAN) that is shared by multiple, geographically distributed computers. IoT sensor set 1825 is made up of sensors that can be used in Internet of Things applications. For example, one sensor may be a thermometer and another sensor may be a motion detector.

NETWORK MODULE 1815 is the collection of computer software, hardware, and firmware that allows computer 1801 to communicate with other computers through WAN 1802. Network module 1815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1815 are performed on the same physical hardware device. In other embodiments (for example, embodiments that utilize software-defined networking (SDN)), the control functions and the forwarding functions of network module 1815 are performed on physically separate devices, such that the control functions manage several different network hardware devices. Computer readable program instructions for performing the inventive methods can typically be downloaded to computer 1801 from an external computer or external storage device through a network adapter card or network interface included in network module 1815.

WAN 1802 is any wide area network (for example, the internet) capable of communicating computer data over non-local distances by any technology for communicating computer data, now known or to be developed in the future. In some embodiments, the WAN 1802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1803 is any computer system that is used and controlled by an end user (for example, a customer of an enterprise that operates computer 1801), and may take any of the forms discussed above in connection with computer 1801. EUD 1803 typically receives helpful and useful data from the operations of computer 1801. For example, in a hypothetical case where computer 1801 is designed to provide a recommendation to an end user, this recommendation would typically be communicated from network module 1815 of computer 1801 through WAN 1802 to EUD 1803. In this way, EUD 1803 can display, or otherwise present, the recommendation to an end user. In some embodiments, EUD 1803 may be a client device, such as thin client, heavy client, mainframe computer, desktop computer and so on.

REMOTE SERVER 1804 is any computer system that serves at least some data and/or functionality to computer 1801. Remote server 1804 may be controlled and used by the same entity that operates computer 1801. Remote server 1804 represents the machine(s) that collect and store helpful and useful data for use by other computers, such as computer 1801. For example, in a hypothetical case where computer 1801 is designed and programmed to provide a recommendation based on historical data, then this historical data may be provided to computer 1801 from remote database 1830 of remote server 1804.

PUBLIC CLOUD 1805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1805 is performed by the computer hardware and/or software of cloud orchestration module 1841. The computing resources provided by public cloud 1805 are typically implemented by virtual computing environments that run on various computers making up the computers of host physical machine set 1842, which is the universe of physical computers in and/or available to public cloud 1805. The virtual computing environments (VCEs) typically take the form of virtual machines from virtual machine set 1843 and/or containers from container set 1844. It is understood that these VCEs may be stored as images and may be transferred among and between the various physical machine hosts, either as images or after instantiation of the VCE. Cloud orchestration module 1841 manages the transfer and storage of images, deploys new instantiations of VCEs and manages active instantiations of VCE deployments. Gateway 1840 is the collection of computer software, hardware, and firmware that allows public cloud 1805 to communicate through WAN 1802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1806 is similar to public cloud 1805, except that the computing resources are only available for use by a single enterprise. While private cloud 1806 is depicted as being in communication with WAN 1802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1805 and private cloud 1806 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

What is claimed is:

1. A method for providing a quantum variable, comprising:
providing a quantum register comprising a set of qubits defining a quantum system;
representing states of the quantum system in a computational basis by an ordered set of consecutive nonnegative integer numbers, referred to as a set of indexes;
determining a random variable in accordance with a predefined classical-quantum format, wherein the random variable is valued in a finite domain of classical values such that each value of the domain is derived from a respective index of the set of indexes through an affine relationship, the affine relationship being defined by a scaling factor and an offset factor; and
encoding the set of qubits to represent the random variable, wherein the encoding is performed such that the probability of measuring a state of the quantum system in the computational basis is the probability of observing the domain value associated with the index representing said measured state when sampling the random variable.

2. The method of claim 1, wherein determining the random variable in accordance with the classical-quantum format further comprises:
determining a tolerance range;
performing the encoding such that an approximate of the domain value and the domain value are represented with the same quantum state in case the difference between the domain value and the approximate is within the tolerance range.

3. A method for providing quantum variables, comprising:
providing a first quantum register comprising a first set of qubits defining a first quantum system and a second quantum register comprising a second set of qubits defining a second quantum system;
representing states of the first quantum system in a computational basis by an ordered set of consecutive first indexes;
representing states of the second quantum system in a computational basis by an ordered set of consecutive second indexes;
determining a first random variable and a second random variable of a classical-quantum format, the first random variable being valued in a finite first domain of classical values such that each value of the first domain is derived from a respective first index of the set of first indexes through a first affine relationship, the first affine relationship being defined by a first scaling factor and a first offset factor, the second random variable being valued in a finite second domain of classical values such that each value of the second domain is derived from a respective second index of the set of second indexes through a second affine relationship, the second affine relationship being defined by a second scaling factor and a second offset factor; and
encoding the first set of qubits and the second set of qubits for representing the first and second random variables.

4. The method of claim 3, the first and second random variables being independent, wherein the encoding comprises:
encoding the first set of qubits such that the probability of measuring a state of the first quantum system in the computational basis is the probability of observing the first domain value associated with the first index representing said measured state when sampling the first random variable; and
encoding the second set of qubits such that the probability of measuring a state of the second quantum system in the computational basis is the probability of observing the second domain value associated with the second index representing said measured state when sampling the second random variable.

5. The method of claim 3, the first and second random variables being dependent, wherein the encoding of the first and second sets of qubits is performed such that the probability of measuring a state of a joint quantum system of the first and second quantum systems in the computational basis is the probability of jointly observing the first domain value associated with the first index representing said measured state when sampling the first random variable and the second domain value associated with the second index representing said measured state when sampling the second random variable.

6. The method of claim 3, further comprising determining a sum of the first and second random variables, the determining of the sum comprising:
providing an output quantum register comprising a third set of qubits, thereby defining a third quantum system, the first, second and third quantum systems forming a joint quantum system;
determining a first set of weights for the first set of qubits respectively and a second set of weights for the second set of qubits respectively, the determining is performed such that the output quantum register after performing the sum represents a third random variable of the classical-quantum format;
defining an unknown for each qubit of the first and second quantum registers;
defining a monomial for each unknown, the monomial being the unknown multiplied by the weight associated to the respective qubit;
defining a polynomial as the sum of the monomials;
generating a unitary quantum transformation that is configured to act on the first quantum register and second quantum register, on the output quantum register, and on an auxiliary register, in order to evaluate the polynomial into the output quantum register; and
applying the unitary quantum transformation on the first quantum register and second quantum register, thereby encoding the third set of qubits such that the states of the third quantum system in the computational basis represent values of a third random variable of the classical-quantum format.

7. The method of claim 6, wherein the states of the third quantum system in the computational basis represent values of the third random variable of the classical-quantum format through a third affine relationship defined by a third scaling factor and a third offset factor, wherein the third offset factor is the classical sum of the first and second offsets and the third scaling factor is the product of an alignment scale and a predefined target scale, wherein the alignment scale is the inverse of a power of two such that the sum can be performed without overflow.

8. The method of claim 7, wherein the alignment scale is equal to the inverse of two to the power of an integer M, where M is an integer so that the sum of the absolute value of the weights in the first set of weights and in the second set of weights is smaller than or equal to the maximal index of the output quantum register.

9. The method of claim 7, the target scale being one of the first and second scaling factors.

10. The method of claim 8, wherein the determining of the first and second set of weights is iteratively performed by at least:
initializing the integer M to an upper bound;
determining current first set of weights and second set of weights;
computing the sum of the absolute value of the weights in the first set of weights and second set of weights;
determining whether the sum is smaller than or equal to the maximal index of the output quantum register;
decreasing M by 1 and repeating the determining the current first set and second set of weights, the computing the sum of the absolute value of weights and the determining whether the sum is smaller than or equal to the maximal index in response to a determination that the sum is higher than the maximal index of the output quantum register; and
providing the last determined first set of weights and second set of weights.

11. The method of claim 10, the providing of the first set and second set of weights further comprising lowering the number of qubits in the output quantum register to a closest number of the sum that is a power of two.

12. The method of claim 6, the sum being determined in place, wherein the output quantum register is one of the first and second quantum registers.

13. The method of claim 3, further comprising performing a multiplication of the first and second random variables, the performing of the multiplication comprising:
providing an output quantum register comprising a third set of qubits, thereby defining a third quantum system, the first, second and third quantum systems forming a joint quantum system;
determining a first set of weights for the first set of qubits respectively and a second set of weights for the second set of qubits respectively and a third set of qubits for the pairs of qubits of the first set and second set of qubits respectively, the determining being performed such that the output quantum register after performing the multiplication represents a third random variable of the classical-quantum format;
defining an unknown for each qubit of the first and second quantum registers;
defining a polynomial as a sum of first degree monomials and second degree monomials, wherein each first degree monomial is associated with respective qubit of the first and second set of qubits, wherein each first degree monomial is defined as the product of the unknown and a weight associated with the respective qubit, wherein each second degree monomial is associated with respective pair of qubits of the first and second set of qubits, wherein each second degree monomial is defined as the product of the two unknowns associated to the two respective qubits and a weight associated with the respective pair of qubits;
generating a unitary quantum transformation that is configured to act on the first quantum register and second quantum register, on the output quantum register, and on an auxiliary register, in order to evaluate the polynomials into the output quantum register;
applying the unitary quantum transformation on the first and second quantum registers, thereby encoding the third set of qubits such that the states computational basis of the of the third quantum system represent values of a third random variable of the classical-quantum format.

14. The method of claim 13, wherein the states of the computational basis of the third quantum system represent values of the third random variable of the classical-quantum format through a third affine relationship defined by a third scaling factor and a third offset factor, wherein the third offset factor is the classical product of the first and second offsets and the third scaling factor is a given target scale.

15. The method of claim 13, each weight comprising an alignment scale, wherein the alignment scale is equal to the inverse of two to the power of an integer M, where M is an integer so that the sum of the absolute value of the weights in the first set of weights and in the second set of weights and in the third set of weights is smaller than or equal to the maximal index of the output quantum register, wherein the alignment scale is provided such that the product can be performed without overflow.

16. The method of claim 14, the target scale being one of the first and second scaling factors.

17. The method of claim 13, wherein the determining the first, second and third set of weights is iteratively performed by at least:
determining current first set of weights, second set of weights and third set of weights;
computing the sum of the first set of weights, second set of weights and third set of weights;
determining whether the sum is smaller than or equal to the maximal index of the output quantum register;
decreasing M by 1 and repeating the determining the current first set weights, second set of weights and third set of weights, the computing the sum of weights and the determining whether the sum is smaller than or equal to the maximal index in response to a determination that the sum is higher than the maximal index of the output quantum register; and
providing the last determined first set of weights, second set of weights and third set of weights.

18. The method of claim 15, the providing of the first set, second set and third set of weights further comprising lowering the number of qubits in the output quantum register to a power of two number which is closest to the sum.

19. The method of claim 1, further comprising performing a quantum algorithm using the method as a subroutine and using the same quantum registers.

20. The method of claim 1, the scaling factor being a nonzero real number and/or the offset factor being a real number.

21. The method of claim 6, wherein the determining the sum is performed with a first quantum register, a second quantum register and a third quantum register.

22. A computer system comprising a quantum register comprising a set of qubits defining a quantum system; the computer system being configured for:
representing states of the quantum system in a computational basis by an ordered set of consecutive nonnegative integer numbers, referred to as a set of indexes;
determining a random variable in accordance with a predefined classical-quantum format, wherein the random variable is valued in a finite domain of classical values such that each value of the domain is derived from a respective index of the set of indexes through an affine relationship, the affine relationship being defined by a scaling factor and an offset factor; and
encoding the set of qubits such that the probability of measuring a state of the quantum system in the computational basis is the probability of observing the domain value associated with the index representing said measured state when sampling the random variable.

23. A computer program product comprising a computer-readable storage medium having computer-readable program code embodied therewith, the computer-readable program code configured to cause a processor to:
provide a quantum register comprising a set of qubits defining a quantum system;
represent states of the quantum system in a computational basis by an ordered set of consecutive nonnegative integer numbers, referred to as a set of indexes;
determine a random variable in accordance with a predefined classical-quantum format, wherein the random variable is valued in a finite domain of classical values such that each value of the domain is derived from a respective index of the set of indexes through an affine relationship, the affine relationship being defined by a scaling factor and an offset factor; and
encode the set of qubits to represent the random variable, wherein the encoding is performed such that the probability of measuring a state of the quantum system in the computational basis is the probability of observing the domain value associated with the index representing said measured state when sampling the random variable.

24. A method for providing a quantum variable, comprising:
providing a quantum register comprising a set of qubits defining a quantum system;
representing states of the quantum system in a computational basis by an ordered set of consecutive nonnegative integer numbers, referred to as a set of indexes;
determining a set of ordered pairs, where a first element of each ordered pair is a complex number, such that the sum of all the squared absolute values of the complex numbers across the set equals one, and a second element of each pair is a real number in a finite domain of classical values, the real number being derived from a respective index of the set of indexes through an affine relationship, the affine relationship being defined by a scaling factor and an offset factor; and
encoding the set of qubits to represent the set of ordered pairs, wherein the encoding is performed such that the quantum state is the complex linear combination of states of the computational basis, where the coefficients of the linear combination are the first elements in the ordered pairs, and the states of the computational basis are represented by the respective indexes, each index being the index in the set of indexes associated to the respective second element of the ordered pair.
